(19) United States
(12) Patent Application Publication
(10) Pub. No.: US 2023/0162023 A1
(43) Pub. Date: May 25, 2023

(54) System and Method for Automated Transfer Learning with Domain Disentanglement

(71) Applicant: Mitsubishi Electric Research Laboratories, Inc., Cambridge, MA (US)

(72) Inventors: Toshiaki Koike Akino, Cambridge, MA (US); Ye Wang, Cambridge, MA (US); Niklas Smedemark-Margulies, Cambridge, MA (US)

(73) Assignee: Mitsubishi Electric Research Laboratories, Inc., Cambridge, MA (US)

(21) Appl. No.: 17/649,578

(22) Filed: Feb. 1, 2022

Related U.S. Application Data
(60) Provisional application No. 63/264,582, filed on Nov. 25, 2021.

(51) Int. Cl. G06N 3/08; G06N 3/04

(52) U.S. Cl. CPC G06N 3/08; G06N 3/04

(57) ABSTRACT

A system and method for automated construction of an artificial neural network architecture are provided. The system includes a set of interfaces and data links configured to receive and send signals, wherein the signals include datasets of training data, validation data and testing data, wherein the signals include a set of random number factors in multi-dimensional signals, wherein part of the random number factors are associated with task labels to identify, and nuisance variations. The system further includes a set of memory banks to store a set of reconfigurable deep neural network (DNN) blocks, hyperparameters, trainable variables, intermediate neuron signals, and temporary computation values including forward-pass signals and backward-pass gradients. The system further includes at least one processor, in connection with the interface and the memory banks, configured to submit the signals and the datasets into the reconfigurable DNN blocks, wherein the at least one processor is configured to explore hyperparameters of regularization modules, pre-processing and post-processing methods such that the reconfigurable DNN blocks achieve nuisance-robust Bayesian inference to be transferable to new datasets with domain shifts.

### FIELD OF THE INVENTION

The present invention is related to an automated training system of an artificial neural network, and more particularly to an automated transfer learning and domain adaptation system of an artificial neural network with nuisance-factor disentanglement.

### BACKGROUND & PRIOR ART

The great advancement of deep learning techniques based on deep neural networks (DNN) has resolved various issues in data processing, including media signal processing for video, speech, and images, physical data processing for radio wave, electrical pulse, and optical beams, and physiological data processing for heart rate, temperature, and blood pressure. For example, DNNs enabled more practical design of human-machine interfaces (HMI) through the analysis of the user's biosignals, such as electroencephalogram (EEG) and electromyogram (EMG). However, such biosignals are highly subject to variation depending on the biological states of each subject as well as measuring sensors' imperfection and experimental setup inconsistency. Hence, frequent calibration is often required in typical HMI systems. Besides HMI systems, data analysis often encounters numerous nuisance factors such as noise, interference, bias, domain shifts and so on. Therefore, deep learning which is robust against those nuisance factors across different dataset domains is demanded.

Toward resolving this issue, nuisance-invariant methods, employing adversarial training such as Adversarial Conditional Variational AutoEncoder (A-CVAE), have emerged to reduce domain calibration for realizing cross-domain generalized deep learning, such as subject-invariant HMI systems. Compared to a standard DNN classifier/regressor, integrating additional functional blocks such as encoder, nuisance-conditional decoder, and adversary networks, offers excellent nuisance-invariant performance because of the gain of domain generalization even without new domain data. The DNN structure may be potentially extended with more functional blocks and more latent layers. However, most works rely on human design to determine the block connectivity and architecture of DNNs. Specifically, DNN techniques are often hand-crafted by experts who design data models with human insights. How to optimize the architecture of DNN requires trial and error approaches. A new framework of automated machine learning (AutoML) was proposed to automatically explore different DNN architectures. Automation of hyperparameter and architecture exploration in the context of AutoML can facilitate DNN design suited for nuisance-invariant data processing. Besides architectures of DNN, there are numerous approaches to stabilize the behaviors of DNN training by regularizing trainable parameters, such as adversarial disentanglement, and L2/L1-norm regularizations.

Learning data representations that capture task-related features, but are invariant to nuisance variations remains a key challenge in machine learning. The VAE introduced variational Bayesian inference methods, incorporating autoassociative architectures, where generative and inference models can be learned jointly. This method was extended with the CVAE, which introduces a conditioning variable that could be used to represent the nuisance variation, and a regularized VAE, which considers disentangling the nuisance variable from the latent representation. The concept of adversarial learning was considered in Generative Adversarial Networks (GAN), and has been adopted into myriad applications. The simultaneously discovered Adversarially Learned Inference (ALI) and Bidirectional GAN (BiGAN) proposed an adversarial approach toward training an autoencoder. Adversarial training has also been combined with VAE to regularize and disentangle the latent representations so that nuisance-robust learning is realized. Searching DNN models with hyperparameter optimization has been intensively investigated in a related framework called AutoML. The automated methods include architecture search, learning rule design, and augmentation exploration. Most work used either evolutionary optimization or reinforcement learning framework to adjust hyperparameters or to construct network architecture from pre-selected building blocks. Recent AutoML-Zero considers an extension to preclude human knowledge and insights for fully automated designs from scratch.

However, AutoML requires a lot of exploration time to find the best hyperparameters due to the search space explosion. In addition, without any good reasoning, most search space of link connectives will be pointless. In order to develop a system for an automated construction of a neural network with justifiability, a method called AutoBayes was proposed. The AutoBayes method explores different Bayesian graphs to represent inherent graphical relation among variables data for generative models, and subsequently construct the most reasonable inference graph to connect an encoder, decoder, classifier, regressor, adversary, and domain estimator. With the so-called Bayes ball algorithm, the most compact inference graph for a particular Bayesian graph can be automatically constructed, and some factors are identified as a variable independent of a domain factor to be censored by an adversarial block. The adversarial censoring to disentangle nuisance factors from feature spaces was verified effective for domain generalization in pre-shot transfer learning and domain adaptation in post-shot transfer learning.

However, adversarial training requires careful choice of hyperparameters because too strong censoring will hurt the main task performance as the main objective function is under-weighted. Moreover, adversarial censoring is not only sole regularization approach to promote independence from nuisance variables in feature space. For example, minimizing mutual information between nuisance and feature can be realized by mutual information gradient estimator (MIGE). Similarly, there are different such censoring approaches and scoring methods to consider. Because of the so-called no free-lunch theorem, there is no single method which can universally achieve best performance across different problems and datasets. Exploring domain disentanglement approaches requires time-/resource-intensive trial and error to find the best solutions. Accordingly, there is a need to efficiently identify the best censoring approach dependent on particular problem for nuisance-robust transfer learning.

### SUMMARY OF THE INVENTION

The present invention provides a way to design machine learning models so that nuisance factors are seamlessly disentangled by exploring various hyperparameters of censoring modes and censoring methods for domain shift-robust transfer learning over pre-shot phase and post-shot phase. The invention enables AutoML to efficiently search for potential transfer learning modules, and thus we call it an AutoTransfer framework. One embodiment uses a joint categorical and continuous search space across different censoring modes and censoring methods with censoring hyperparameters to adjust levels of domain disentangling. The censoring modes include but are not limited to marginal distribution, conditional distribution, and complementary distribution for controlling modes of disentanglement. The censoring methods encourage features within machine learning models to be independent of nuisance parameters, so that nuisance-robust feature extraction is realized. However, too strong censoring will degrade the downstream task performance in general, and hence the AutoTransfer adjusts the hyperparameters to seek the best trade-off between task-discriminative feature and nuisance-invariant feature. The censoring methods include but not limited to adversarial network, mutual information gradient estimation (MTGE), pairwise discrepancy, and Wasserstein distance.

The invention provides a way to adjust those hyperparameters under an AutoML framework such as Bayesian optimization, reinforcement learning, and heuristic optimization. Yet another embodiment explores different pre-processing mechanisms, which include domain-robust data augmentation, filter bank, and wavelet kernel to enhance nuisance-robust inference across numerous different data formats such as time-series signal, spectrogram, cepstrum, and other tensors. Another embodiment uses variational sampling for semi-supervised setting where nuisance factors are not fully available for training. Another embodiment provides a way to transform one data structure to another data structure of mismatched dimensionality, by using tensor projection with optimal transport methods and independent component mapping with common spatial patterns to enable heterogeneous transfer learning. One embodiment realizes the ensemble methods exploring stacking protocols over cross validation to reuse multiple explored models at once. Besides pre-shot transfer learning (where there is zero available data in a target domain when training phase), the invention also provides post-shot transfer learning (where there are some available data in a target domain when training or fine-tuning phase) such as zero-shot learning (where all data in the target domain are unlabled), 1-shot learning, and few-shot learning. A hyper-network adaptation provides a way to automatically generate an auxiliary model which directly controls the parameters of the base inference model by analyzing consistent evolution behaviors in hypothetical post-shot learning phases. The post-shot learning includes but not limited to successive unfreezing and fine tuning with confusion minimization from a source domain to a target domain with and without pseudo labeling.

The present disclosure relates to systems and methods for an automated construction of an artificial neural network through an exploration of different censoring modules and pre-processing methods. Specifically, the system of the present invention introduces an automated transfer learning framework, called AutoTransfer, that explores different disentanglement approaches for an inference model linking classifier, encoder, decoder, and estimator blocks to optimize nuisance-invariant machine learning pipelines. In one embodiment, the framework is applied to a series of physiological datasets, where we have access to subject and class labels during training, and provide analysis of its capability for subject transfer learning with/without variational modeling and adversarial training. The framework can be effectively utilized in semi-supervised multi-class classification, multi-dimensional regression, and data reconstruction tasks for various dataset forms such as media signals and electrical signals as well as biosignals.

Some embodiments of the present disclosure are based on recognition that a new concept called AutoBayes which explores various different Bayesian graph models to facilitate searching for the best inference strategy, suited for nuisance-robust HMI systems. With the Bayes-Ball algorithm, our method can automatically construct reasonable link connections among classifier, encoder, decoder, nuisance estimator and adversary DNN blocks. We observed a huge performance gap between the best and worst graph models, implying that the use of one deterministic model without graph exploration can potentially suffer a poor classification result. In addition, the best model for one physiological dataset does not always perform best for different data, which encourages us to use AutoBayes for adaptive model generation given target datasets. One embodiment extends the macro-level AutoBayes framework to integrate micro-level AutoML to optimize hyperparameters of each DNN block. The present invention is based on the recognition that some nodes in Bayesian graphs are marginally or conditionally independent to other nodes. The AutoTransfer framework in our invention further explores various censoring modes and methods to promote such independency in particular hidden nodes of DNN models to improve the AutoBayes framework.

Our invention enabled AutoML to efficiently search for potential architectures which have a solid theoretical reason to consider. The method of invention is based on the realization that dataset is hypothetically modeled with a directed Bayesian graph, and thus we call it the AutoBayes method. One embodiment uses Bayesian graph exploration with different factorization orders of the joint probability distribution. The invention also provides a method to create compact architecture with pruning links based on conditional independency derived from the Bayes Ball algorithm over the Bayesian graph hypothesis. Yet another method can optimize the inference graph with different factorization order of likelihood, which enables automatically constructing joint generative and inference graphs. It realizes a natural architecture based on VAE with/without conditional links. Also, another embodiment uses domain disentanglement with auxiliary networks which are attached with latent variables to be independent of nuisance parameters, so that nuisance-robust feature extraction is realized. Yet another case uses intentionally redundant graphs with conditional grafting to promote nuisance-robust feature extraction. Yet another embodiment uses an ensemble graph which combines estimates of multiple different Bayesian graphs and disentangling methods to improve the performance. For example, Wasserstein distance can be also used instead of divergence to measure the independence score. One embodiment realizes the ensemble methods using dynamic attention network. Also cycle consistency of VAE, and model consistency across different inference graphs are jointly dealt with. Another embodiment uses graph neural networks to exploit geometry information of the data, and pruning strategy is assisted by the belief propagation across Bayesian graphs to validate the relevance.

The system provides a way of systematic automation framework, which searches for the best inference graph model associated to Bayesian graph model well-suited to reproduce the training datasets. The proposed system automatically formulates various different Bayesian graphs by factorizing the joint probability distribution in terms of data, class label, subject identification (ID), and inherent latent representations. Given Bayesian graphs, some meaningful inference graphs are generated through the Bayes-Ball algorithm for pruning redundant links to achieve high-accuracy estimation. In order to promote robustness against nuisance parameters such as subject IDs, the explored Bayesian graphs can provide reasoning to use domain disentangling with/without variational modeling. As one of embodiment, AutoTranser with AutoBayes can achieve excellent performance across various physiological datasets for cross-subject, cross-session, and cross-device transfer learning.

In the system of the present invention, a variety of different censoring methods for transfer learning is considered, e.g., for the classification of biosignals data. The system is established to deal with the difficulty of transfer learning for biosignals as known as the issue of “negative transfer”, in which naive attempts to combine datasets from multiple subjects or sessions can paradoxically decrease model performance, due to domain differences in response statistics. The method of the invention addresses the problem of such a subject transfer by training models to be invariant to changes in a nuisance variable representing the subject identifier. Specifically, the method automatically examines several established approaches to construct a set of good approaches based on mutual information estimation and generative modeling. For example, the method is enabled for a real-world dataset such as a variety of electroencephalography (EEG), electromyography (EMG), and electrocorticography (ECoG) datasets, showing that these methods can improve generalization to unseen test subjects. Some embodiments also explore ensembling strategies for combining the set of these good approaches into a single meta-model, gaining additional performance. Further exploration of these methods through hyperparameter tuning can yield additional generalization improvements. For some embodiments, the system and method can be combined with existing test-time online adaptation techniques from the zero-shot and few-shot learning frameworks to achieve even better subject-transfer performance.

The key approach to the transfer learning problem is to censor an encoder model, such that it learns a representation that is useful for the task while containing minimal information about changes in a nuisance variable that will vary as part of our transfer learning setup. Specifically, we consider a dataset consisting of high-dimensional data (e.g., raw EEG input), with task-relevant labels (e.g., EEG task categories) and nuisance labels (e.g., subject ID or writer ID). Intuitively, we seek to learn a representation that only captures variation that is relevant for the task. The motivation behind this approach is related to the information bottleneck method, though with a key difference. Whereas the information bottleneck method and its variational variant seek to learn a useful, compressed representation from a supervised dataset without any additional information about nuisance variation, we explicitly use additional nuisance labels in order to draw conclusions about the types of variation in the data that should not affect our model's output. Many transfer learning settings will have such nuisance labels readily available, and intuitively, the model should benefit from this additional source of supervision. The system can offer a non-obvious benefit to learn subject-invariant representations by exploring a variety of regularization modules for domain disentanglement.

Further, according to some embodiments of the present invention, a system for automated construction of an artificial neural network architecture is provided. In this case, the system may include a set of interfaces and data links configured to receive and send signals, wherein the signals include datasets of training data, validation data and testing data, wherein the signals include a set of random variable factors in multi-dimensional signals X, wherein part of the random variable factors are associated with task labels Y to identify, and nuisance variations S; a set of memory banks to store a set of reconfigurable DNN blocks, wherein each of the reconfigurable DNN blocks is configured with main task pipeline modules to identify the task labels Y from the multi-dimensional signals X and with a set of auxiliary regularization modules to adjust disentanglement between a plurality of latent variables Z and the nuisance variations S, wherein the memory banks further include hyperparameters, trainable variables, intermediate neuron signals, and temporary computation values including forward-pass signals and backward-pass gradients; at least one processor, in connection with the interface and the memory banks, configured to submit the signals and the datasets into the reconfigurable DNN blocks, wherein the at least one processor is configured to execute an exploration over a set of graphical models, a set of pre-shot regularization methods, a set of pre-processing methods, a set of post-processing methods, and a set of post-shot adaptation methods, to reconfigure the reconfigurable DNN blocks such that the task prediction is insensitive to the nuisance variations S by modifying the hyperparameters in the memory banks.

Yet further, some embodiments of the present invention provide a computer-implemented method for automated construction of an artificial neural network architecture. The computer-implemented method may include feeding datasets of training data, validation data and testing data, wherein the datasets include a set of random variable factors in multi-dimensional signals X, wherein part of the random variable factors are associated with task labels Y to identify, and nuisance variations S; configuring a set of reconfigurable DNN blocks to identify the task labels Y from the multi-dimensional signals X, wherein the set of DNN blocks comprises a set of auxiliary regularization modules to adjust disentanglement between a plurality of latent variables Z and the nuisance variations S; training the set of reconfigurable DNN blocks via a stochastic gradient optimization such that a task prediction is accurate for the training data; exploring the set of auxiliary regularization modules to search for the best hyperparameters such that the task prediction is insensitive to the nuisance variations S for the validation data.

### BRIEF DESCRIPTION OF THE DRAWINGS

The accompanying drawings, which are included to provide a further understanding of the invention, illustrate embodiments of the invention and together with the description, explaining the principle of the invention.

FIGS. 1(a), 1(b) and 1(c) show the inference methods to classify Y given data X under latent Z and semi-labeled nuisance S, according to embodiments of the present disclosure;

FIGS. 2(a)-2(c) show exemplar Bayesian graph models and interference models for particular factorizations, according to some embodiments of the present disclosure;

FIGS. 3(a)-3(k) show exemplar Bayesian graph models for data generative models under automated exploration, according to some embodiments of the present disclosure;

FIGS. 4(a)-4(l) show exemplar inference factor-graph models relevant for particular generative models, according to some embodiments of the present disclosure;

FIGS. 5(a)-5(j) show ten basic rules of the Bayes-Ball algorithm with shaded conditional nodes as conditional factors, according to embodiments of the present disclosure;

FIG. 6 shows an exemplar algorithm describing the overall procedure of the AutoBayes algorithm for exploring the model architecture, according to embodiments of the present disclosure;

FIGS. 7A and 7B show exemplar algorithms describing the overall procedure of subset selections for pairwise score estimations based on Belinouli and clique criteria, according to embodiments of the present disclosure;

FIG. 8 shows an exemplar model to predict a task label Y from a data X in a main pipeline of an encoder f and a decoder g, where a latent factor Z is regularized by a set of censoring methods to disentangle a nuisance factor S, according to embodiments of the present disclosure;

FIGS. 9A, 9B, and 9C show exemplar pseudocodes describing adversarial censoring methods in marginal censoring mode, conditional censoring mode, and complementary censoring mode, according to embodiments of the present disclosure;

FIGS. 10A, 10B, and 10C show exemplar pseudocodes describing mutual information gradient estimation (MIGE)-based censoring methods in marginal censoring mode, conditional censoring mode, and complementary censoring mode, according to embodiments of the present disclosure;

FIGS. 11A, 11B, and 11C show exemplar pseudocodes describing maximum mean discrepancy (MMD)-based censoring methods in marginal censoring mode, conditional censoring mode, and complementary censoring mode, according to embodiments of the present disclosure;

FIGS. 12A, 12B, and 12C show exemplar pseudocodes describing pairwise MMD-based censoring methods in marginal censoring mode, conditional censoring mode, and complementary censoring mode, according to embodiments of the present disclosure;

FIGS. 13A, 13B, and 13C show exemplar pseudocodes describing boundary equilibrium generative adversarial network (BEGAN) discriminator-based censoring methods in marginal censoring mode, conditional censoring mode, and complementary censoring mode, according to embodiments of the present disclosure;

FIGS. 14(a), 14(b), 14(c) and 14(d) show an exemplar set of post-processing modules used in post-shot adaptation phase, according to embodiments of the present disclosure;

FIGS. 15(a), 15(b), 15(c), 15(d), 15(e), and 15(f) show an exemplar set of pre-processing modules, according to embodiments of the present disclosure; and

FIG. 16 shows a schematic of the system configured with processor, memory and interface, according to embodiments of the present disclosure.

### DETAILED DESCRIPTION OF THE PREFERRED EMBODIMENTS

Various embodiments of the present invention are described hereafter with reference to the figures. It would be noted that the figures are not drawn to scale elements of similar structures or functions are represented by like reference numerals throughout the figures. It should be also noted that the figures are only intended to facilitate the description of specific embodiments of the invention. They are not intended as an exhaustive description of the invention or as a limitation on the scope of the invention. In addition, an aspect described in conjunction with a particular embodiment of the invention is not necessarily limited to that embodiment and can be practiced in any other embodiments of the invention.

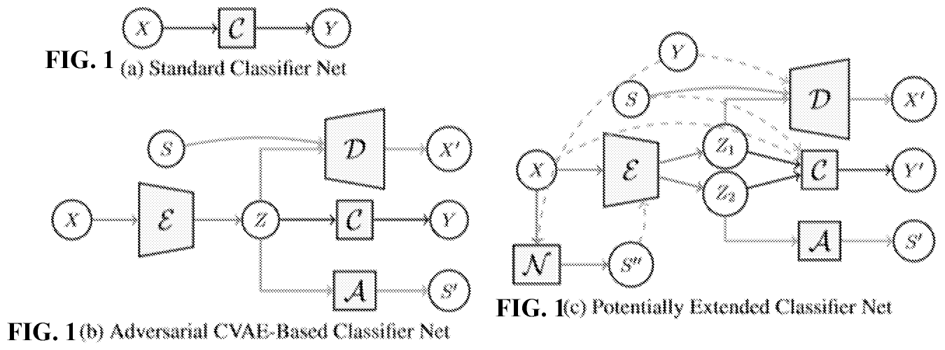

FIG. 1(a) shows an exemplar schematic of an artificial intelligence (AI) model, which provides an inference to identify a task label Y from an observation data X. The task label is either categorical identity numbers or non-categorical continuous values. For categorical inference, the AI model performs a classification task, while the model performs a regression task for non-categorical inference. The task label is either a scalar value or a vector of multiple values. The observation data are tensor formats with at least one axis to represent numerous signals and sensor data, including but not limited to:
media data such as images, pictures, movies, texts, letters, voices, music, audios, and speech;
physical data such as radio waves, optical signals, electrical pulses, temperatures, pressures, accelerations, speeds, vibrations, mass, moisture, and forces; and
physiological data such as heart rate, blood pressure, electroencephalogram, electromyogram, electrocardiogram, mechanomyogram, electrooculogram, galvanic skin response, magnetoencephalogram, and electrocorticography.

For example, the AI model predicts an emotion from brainwave measurement of a user, where the data is a three-axis tensor representing a spatio-temporal spectrogram from multiple-channel sensors over a measurement time. All available data signals with a pair of X and Y are bundled as a whole batch of dataset for training the AI model, and they are called training data or training dataset for supervised learning. For some embodiments, the task label Y is missing for a fraction of the training dataset as a semi-supervised setting.

The AI model can be realized by a reconfigurable deep neural network (DNN) model, whose architecture is specified by a set of hyperparameters. The set of hyperparameters include but not limited to: the number of hidden nodes; the number of hidden layers; types of activation functions; graph edge connectivity; combinations of cells. The reconfigurable DNN architecture is typically based on a multi-layer perceptron using combinations of cells such as fully-connected layers, convolutional layers, recurrent layers, pooling layers, and normalization layers, having a number of trainable parameters such as affine-transform weights and biases. The types of activation functions include but not limited to: sigmoid; hard sigmoid; log sigmoid; tanh; hard tanh; softmax; soft shrink; hard shrink; tanh shrink; rectified linear unit; soft sign; exponential linear unit; sigmoid linear unit; mish; hard swish; soft plus. The graph edge connectivity includes but not limited to: skip addition; skip concatenation; skip product; branching; looping. For example, a residual network uses skip connections from a hidden layer to another hidden layer, that enables stable learning of deeper layers.

The DNN model is trained for the training dataset to minimize or maximize an objective function by gradient methods such as stochastic gradient descent, adaptive momentum gradient, root-mean-square propagation, adaptive gradient, adaptive delta, adaptive max, resilient backpropagation, and weighted adaptive momentum. For some embodiments, the training dataset is split into multiple sub-batches for local gradient updating. For some embodiments, a fraction of the training dataset is held out for validation dataset to evaluate the performance of the trained DNN model. The validation dataset from the training dataset is circulated for cross validation in some embodiments. The way to split the training data into sub-batches for cross validations includes but not limited to: random sampling; weighted random sampling; one session held out; one subject held out; one region held out. Typically, the data distribution for each sub-batch is non identical due to a domain shift.

The gradient-based optimization algorithms have some hyperparameters such as learning rate and weight decay. The learning rate is an important parameter to choose, and can be automatically adjusted by some scheduling methods such as a step function, exponential function, trigonometric function, and adaptive decay on plateau. Non-gradient optimization such as evolutionary strategy, genetic algorithm, differential evolution, and Nelder-Mead can be also used. The objective function includes but not limited to: L1 loss; mean-square error loss; cross entropy loss; connectionist temporal classification loss; negative log likelihood loss; Kullback-Leibler divergence loss; margin ranking loss; hinge loss; Huber loss.

The standard AI model having no guidance for hidden nodes may suffer from a local minimum trapping due to the over-parameterized DNN architecture to solve a task problem. In order to stabilize the training convergence, some regularization techniques are used. For example, L1/L2-norm is used to regularize the affine-transform weights. Batch normalization and dropout techniques are also widely used as common regularization techniques to prevent over-fitting. Other regularization techniques include but not limited to: drop connect; drop block; drop path; shake drop; spatial drop; zone out; stochastic depth; stochastic width; spectral normalization; shake-shake. However, those well-known regularization techniques do not exploit the underlying data distribution. Most datasets have a particular probabilistic relation between X and Y as well as numerous nuisance factors S that disturb the task prediction performance. For example, physiological dataset such as brainwave signals highly depend on subject's mental states and measurement conditions as such nuisance factors S. The nuisance variations include a set of subject identifications, session numbers, biological states, environmental states, sensor states, locations, orientations, sampling rates, time and sensitivities. For yet another example, electro-magnetic dataset such as Wi-Fi signals are susceptible to room environment, ambient users, interference and hardware imperfections. The present disclosure provides a way to efficiently regularize the DNN blocks by considering those nuisance factors so that the AI model is insensitive to a domain shift caused by the change of nuisance factors.

Auxiliary Regularization Modules

The DNN model can be decomposed to an encoder part and a classifier part (or a regressor part for regression tasks), where the encoder part extracts a feature vector as a latent variable Z from the data X, and the classifier part predicts the task label Y from the latent variable Z. For example, the latent variable Z is a vector of hidden nodes at a middle layer of the DNN model. An exemplar pipeline of the AI model configured with the encoder block and the classifier block is illustrated in FIG. 1(b), where the encoder generates Z given X and the decoder predicts Y given Z.

Besides the main pipeline of the encoder and the classifier, FIG. 1(b) shows a schematic illustrating an exemplar DNN block having additional auxiliary regularization modules to regularize the latent variables Z. Specifically, a decoder DNN block is attached with the latent variable Z to reconstruct the original data X with an additional conditional information of the nuisance variations S. This conditional decoder can promote a disentanglement of the nuisance domain information S from the latent variable Z. For example, the nuisance domain variations S include a subject identification (ID), a measurement session ID, noise level, subject's height/weight/age information and so on for physiological datasets. By disentangling those nuisance factors S from the latent variables Z, the present invention can realize a subject-invariant universal human-machine interface without long calibration sessions. The auxiliary DNN block called the decoder is trained to minimize another loss function such as mean-square error or Gaussian negative log likelihood loss to reproduce X from Z.

For some embodiments, the latent variations Z are further decomposed to multiple latent factors Z₁, Z₂, . . . , Z_{L}, each of which is individually regularized by a set of nuisance factors Z₁, Z₂, . . . , Z_{N}. In addition, some nuisance factors are partly known or unknown depending on the datasets. For known labels of nuisance factors, the DNN blocks can be trained in a supervised manner, while it requires a semi-supervised manner for unlabled nuisance factors. For semi-supervised cases, pseudo-labeling based on variational sampling over all potential labels of nuisance factors is used for some embodiments, e.g., based on the so-called Gumbel softmax reparameterization trick. For example, a fraction of data in datasets is missing a subject age information, whereas the rest of data has the age information to be used for supervised regularization.

The DNN blocks in FIG. 1(b) have another auxiliary regularization module attached to the latent variable Z for estimating the nuisance variations S. This regularization DNN block is used to further promote disentangling of nuisance factors to be robust, and often called an adversarial network as the regularization DNN block is trained to minimize a loss function to estimate S from Z while the main pipeline DNN block is trained to maximize the loss function to censor the nuisance information. The adversarial blocks are trained in alternating fashion with associated hyperparameters including an adversarial coefficient, an adversarial learning rate, an interval of adversarial alternation, and an architecture specification.

The graphical model in FIG. 1(b) is known as an adversarial conditional variational autoencoder (A-CVAE) for unsupervised feature extraction for the downstream task classifier. The graphical model of A-CVAE has various graph nodes and graph edges to represent the connectivity over random variable factors X, Y, Z, and S. With the regularization blocks, the A-CVAE model has a higher robustness against the nuisance factors. Accordingly, the auxiliary regularization modules are used as the so-called pre-shot transfer learning or domain generalization techniques to make the AI models robust against unseen nuisance factors.

Architecture Exploration

There are numerous possible ways to connect the encoder, classifier, decoder, and adversarial network blocks. For example, FIG. 1(c) shows one exemplar DNN block where there is another auxiliary model to estimate the nuisance factors S from the data X. As the possible number of realizable DNN connectivities explodes quickly with the size of the AI model, there is a need to efficiently construct reasonable AI model. In addition, randomly connected DNN blocks tend to be useless and un-justifiable. For some embodiments, the graph connectivity is explored by using an automated Bayesian graph exploration method called AutoBayes. At the core of AutoBayes is the consideration of graphical Bayesian models that capture the probabilistic relationship between random variables representing the data features X, task labels Y, nuisance variation labels S, and (potential) latent representations Z. The main goal is to infer the task label Y from the measured data feature X, which is hindered by the presence of nuisance variations (e.g., inter-subject/session variations) that are (partially) labelled by S. Latent representations Z (and further denoted by Z₁, Z₂, . . . , Z_{L} as needed) are also optionally introduced into these AI models to help capture the underlying relationship between S, X, and Y.

We let p(y, s, z, x) denote the joint probability distribution underlying the datasets for the four random variables, Y, S, Z, and X. A chain rule of the probability can yield the following factorization for a generative model from Y to X:

p(y,s,z,x)=p(y)p(s|y)p(z|s,y)p(x|z,s,y)

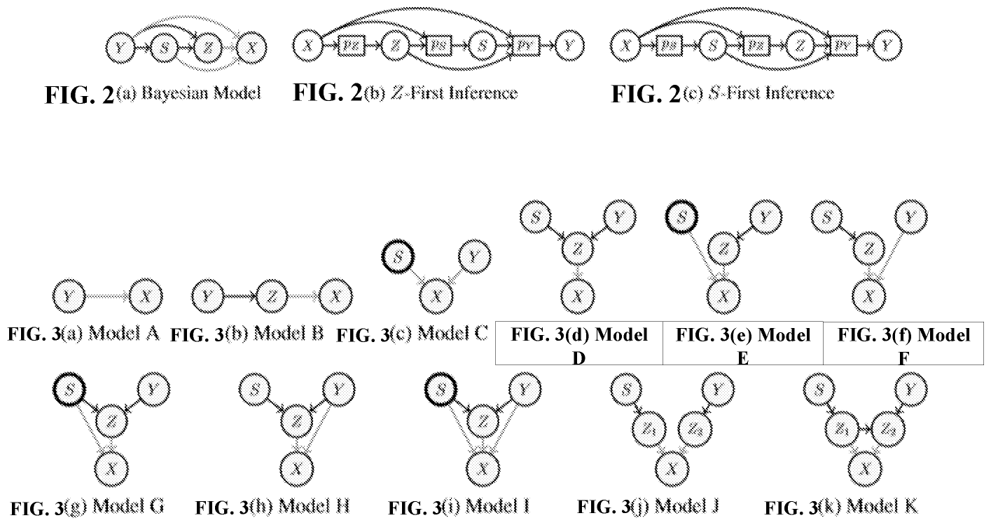

which is visualized in a Bayesian graph of FIG. 2(a). The probability conditioned on X can be factorized, e.g., as follows:

$$p ( y , s , z \vert x ) = \{ \begin{matrix}p ( z \vert x ) p ( s \vert z , x ) p ( y \vert s , z , x ) \\ p ( s \vert x ) p ( z \vert s , x ) p ( y \vert z , s , x )\end{matrix}$$

which are marginalized to obtain the likelihood of task class Y given data X. The above two inference strategies are illustrated in factor graph models in FIGS. 2(b) and 2(c), respectively. The number of possible Bayesian graphs and inference graphs will increase rapidly when considering more nodes with multiple nuisance and latent variables.

The above graphical models in FIGS. 2(a), 2(b) and 2(c) do not impose any assumption of potentially inherent independency in datasets and thus most generic. However, depending on underlying independency in datasets, we may be able to prune some edges in those graphs. For example, if the data has Markov chain of Y−X independent of S and Z, it automatically results into FIG. 1(a). This implies that the most complicated inference model having high degrees of freedom does not always perform best across arbitrary datasets. It motivates us to consider an extended AutoML framework which automatically explores best pair of inference factor graph and corresponding Bayesian graph models matching datasets in addition to the other hyperparameter design.

The AutoBayes begins with exploring any potential Bayesian graphs by cutting links of the full-chain graph in FIG. 2(a), imposing possible independence. We then adopt the Bayes-Ball algorithm on each hypothetical Bayesian graph to examine conditional independence over different inference strategies, e.g., full-chain inference graphs in FIGS. 2(b) and 2(c). The Bayes-Ball justifies the reasonable pruning of the links in the full-chain inference graphs FIGS. 2(b) and 2(c), and also the potential adversary censoring when Z is independent of S. This process automatically constructs a connectivity of inference, generative, and adversary blocks with good reasoning, e.g., to construct A-CVAE classifier in FIG. 1(b) from arbitrary model of FIG. 1(c).

### Exemplar Bayesian Graph Models

Given sensor measurements such as media data, physical data and physiological data, we never know the true joint probability beforehand, and therefore we shall assume one of possible generative models. Unlike usual AutoML framework which searches for inference model architectures, the AutoBayes aims to explore any such potential graph models to match the measurement distributions. As the maximum possible number of graphical models is huge even for a four-node case involving Y, S, Z and X, we show some embodiments of such Bayesian graphs in FIGS. 3(a)-3(k). Each Bayesian graph corresponds to one generative model based on the joint probability factorization.

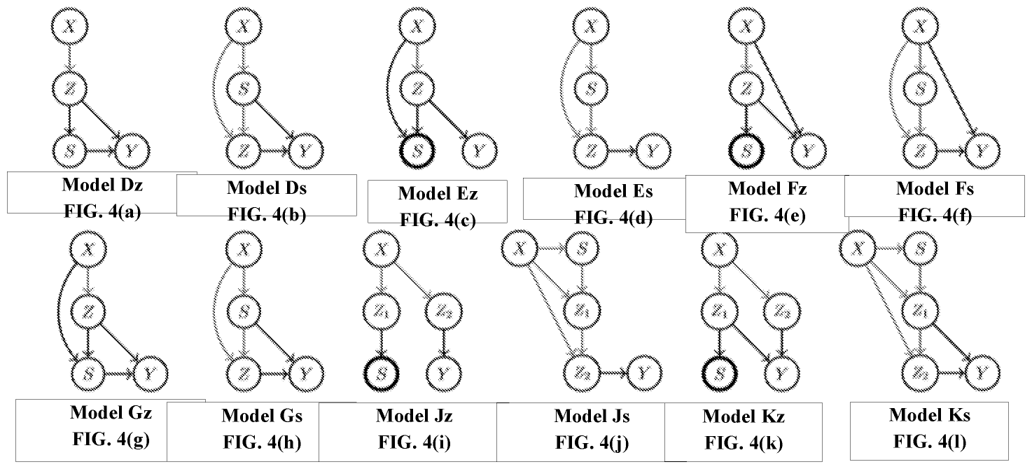

Depending on the assumed Bayesian graph, the relevant inference strategy will be determined such that some variables in the inference factor graph are conditionally independent, which enables pruning links. As shown in FIGS. 4(a)-4(l), the reasonable inference graph model can be automatically generated by the Bayes-Ball algorithm on each Bayesian graph hypothesis inherent in datasets. For example, the generative model E in FIG. 3(e) can automatically generate the inference factor graph model Ez in FIG. 4(c). By merging those generative model and inference model, the AutoBayes can automatically construct a nuisance-robust model based on A-CVAE in FIG. 1(b).

### Bayes-Ball Algorithm

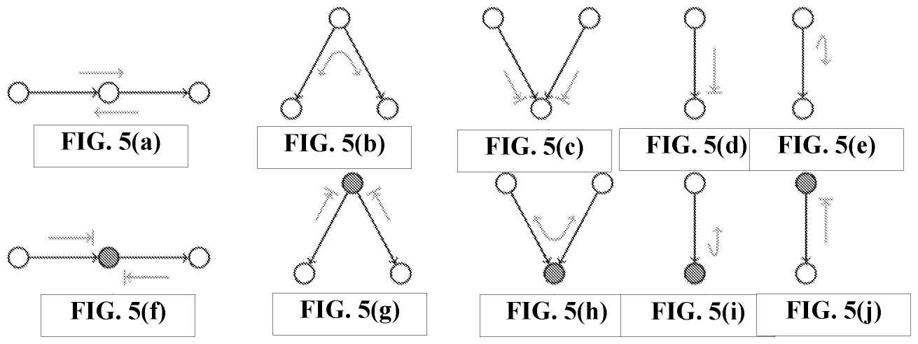

The system of the present invention relies on the Bayes-Ball algorithm to facilitate an automatic pruning of links in inference factor graphs through the analysis of conditional independency. The Bayes-Ball algorithm uses just ten rules to identify conditional independency as shown in FIGS. 5(a)-5(j). Given directed Bayesian graphs, we can determine whether a conditional independence between two disjoint sets of nodes given conditioning on other nodes by applying a graph separation criterion. Specifically, an undirected path is activated if a Bayes ball can travel along without encountering a stopping arrow symbol in FIGS. 5(a)-5(j). If there are no active paths between two sets of nodes when some other conditioning nodes are shaded, then those sets of random variables are conditionally independent. With the Bayes-Ball algorithm, the invention generates a list specifying the independency relationship of two disjoint nodes for AutoBayes algorithm.

### AutoBayes Algorithm

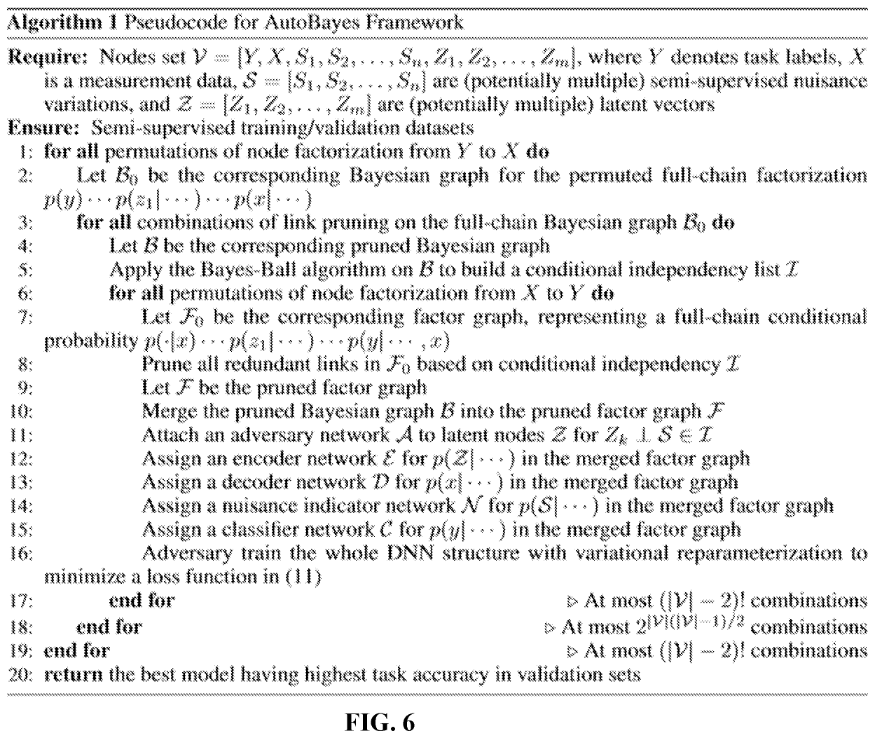

FIG. 6 shows the overall procedure of the AutoBayes algorithm described in the pseudocode of Algorithm 1, according to some embodiments of the present disclosure for more generic cases not only in FIGS. 3(a)-3(k) and FIGS. 4(a)-4(l). The AutoBayes automatically constructs non-redundant inference factor graphs given a hypothetical Bayesian graph assumption, through the use of the Bayes-Ball algorithm. Depending on the derived conditional independency and pruned factor graphs, DNN blocks for encoder, decoder, classifier, nuisance estimator and adversary are reasonably connected. The whole DNN blocks are trained with adversary learning in a variational Bayesian inference. Note that hyperparameters of each DNN block can be further optimized by AutoML on top of AutoBayes framework as one embodiment.

The system of invention uses memory banks to store hyperparameters, trainable variables, intermediate neuron signals, and temporary computation values including forward-pass signals and backward-pass gradients. It reconfigures DNN blocks by exploring various Bayesian graphs based on the Bayes-Ball algorithm such that redundant links are pruned to be compact. Depending on datasets, AutoBayes first creates a full-chain directed Bayesian graph to connect all nodes in a specific permutation order. The system then prunes a specific combination of the graph edges in the full-chain Bayesian graph. Next, the Bayes-Ball algorithm is employed to list up conditional independency relations across two disjoint nodes. For each Bayesian graph in hypothesis, another full-chain directed factor graph is constructed from the node associated with the data signals X to infer the other nodes, in a different factorization order. Pruning redundant links in the full-chain factor graph is then adopted depending on the independency list, thereby the DNN links can be compact. In another embodiment, redundant links are intentionally kept and progressively grafting. The pruned Bayesian graph and the pruned factor graph are combined such that a generative model and an inference model are consistent. Given the combined graphical models, all DNN blocks for encoder, decoder, classifier, estimator, and adversary networks are associated in connection to the model. This AutoBayes realizes nuisance-robust inference which can be transferred to a new data domain for new testing datasets.

The AutoBayes algorithm can be generalized for more than 4 node factors. For example of such embodiments, the nuisance variations S are further decomposed into multiple factors of variations S₁, S₂, . . . , S_{N} as multiple-domain side information according to a combination of supervised, semi-supervised and unsupervised settings. For another example of embodiments, the latent variables are further decomposed into multiple factors of latent variables Z₁, Z₂, . . . , Z_{L} as decomposed feature vectors. FIG. 1(c) is one of such embodiments. For example of an embodiment having decomposed factors, the nuisance variations are grouped into different factors such as subject identifications, session numbers, biological states, environmental states, sensor states, locations, orientations, sampling rates, time and sensitivities.

In the exploration of different graphical models, one embodiment uses output of all different models explored to improve the performance, for example with weighted sum to realize ensemble performance. Yet another embodiment uses additional DNN block which learns the best weights to combine different graphical models. This embodiment is realized with attention networks to adaptively select relevant graphical models given data. This embodiment considers consensus equilibrium and voting across different graphical models as the original joint probability is identical. It also recognizes a cycle consistency of encoder/decoder DNN blocks for some embodiments.

### Censoring Modes

With the AutoBayes architecture exploration, we can identify the independence between the latent variables Z and the nuisance variations S for a given generative model. The auxiliary regularization modules such as an adversarial network and a conditional decoder can assist disentangling the correlation between Z and S for such models. Under a constrained risk minimization framework, there are multiple types of such censoring modes for the auxiliary regularization modules to promote independence between Z and S. In fact, the adversarial censoring is not the only way to accomplish feature disentanglement. Specifically, we consider several modified learning frameworks, in which we enforce some notion of independence between the learned representation Z and the nuisance variable S, so that the classifier model can achieve similar performance across different domains, e.g., using the following censoring modes:

Marginal censoring: in which we attempt to make the latent representations Z marginally independent of the nuisance variables S: p(z,s)≅p(z)p(s). Conditional censoring: in which we attempt to make the representation Z conditionally independent of S, given the task label Y: p (z,s|y)≅p(z|y)p(s|y).

Complementary censoring: in which we partition the latent space into two factors Z=[Z₁, Z₂], such that the first latent variables Z₁ is marginally independent of S, while maximizing the dependence between the second latent variables Z₂ and S: p(z₁,s)≅p(z₁)p(s) and p(z₂,s)≠p(z₂)p(s).

Complementary conditional censoring: in which we partition the latent space into two factors Z=[Z₁, Z₂], such that the first latent variables Z₁ is marginally independent of S given the task label Y, while maximizing the dependence between the second latent variables Z₂ and S given Y: p(z₁, s|y)≅p(z₁|y)p(s|y) and p(z₂,s|y)≠p(z₂|y)p(s|y).

When we have more-than 2 latent representations, the number of censoring modes is naturally increased with a combination of conditional/non-conditional and complementary disentangling.

The first marginal censoring mode captures the simplest notion of a “nuisance-independent representation”. For example, this marginal censoring mode is realized by the adversarial discriminator of the A-CVAE model. When the distribution of labels does not depend on the nuisance variable, this marginal censoring approach will not conflict with the task objective as the nuisance factor S is not useful for the downstream task to predict Y. However, there may exist some correlation between Y and S; thus a representation Z that is trained to be useful for predicting the task labels Y may also be informative of S. The second conditional censoring mode accounts for this conflict between task objective and censoring objective by allowing that Z contains some information about S, but no more than the amount already implied by the task label Y. For example, the A-CVAE model uses the conditional decoder DNN block to accomplish the similar effect of this conditional censoring mode. The third complementary censoring mode accounts for this conflict by requiring one part of the representation Z is independent of the nuisance variable S, while allowing the other part to depend strongly on the nuisance variable. This censoring mode is illustrated in FIG. 1(c).

Those censoring modes lead to considering constrained optimization problems enforcing the desired independence. We consider two forms for this constraint, one based on mutual information and the other based on the divergence between two distributions. Specifically, we solve the constrained optimization problems by using the Lagrange multipliers as follows:

[symbol]

_{Marg}(θ,ϕ)=R(θ,ϕ)+λI(z;s)=R(θ,ϕ)+λ [symbol] (q_{θ}(z|s)∥q_{θ}(z))

[symbol]

_{Cond}(θ,ϕ)=R(θ,ϕ)+λI(z;s|y)=R(θ,ϕ)+λ [symbol] (q_{θ}(z|y,s)∥q_{θ}(z|y))

[symbol]

_{Comp}(θ,ϕ)=R(θ,ϕ)+λ(I(z¹;s)−I(z²;s))=R(θ,ϕ)+λ [symbol] (q_{θ}(z¹|s)∥q_{θ}(z¹))−λ [symbol] (q_{θ}(z²|s)∥q_{θ}(z))

where R (a, b) denotes the main task loss function, I(a; b) is the mutual information, and D (a∥b) is the divergence. The top, middle, and bottom equations correspond to the marginal censoring modes, conditional censoring modes, and complementary censoring modes, respectively. The middle and right-hand sides of the above loss equations correspond to mutual information censoring methods and divergence censoring methods, respectively. The Lagrange multiplier coefficient is used to control the strength of disentanglement.

### Censoring Methods for Estimating Independence

In order to estimate the independence, we consider several censoring methods for computing the mutual information and divergence. For mutual information-based censoring methods, there are some approaches including but not limited to:
Cross entropy loss in adversarial nuisance classifier;
Mutual information neural estimation (MINE);
Mutual information gradient estimation (MIGE).

In an adversarial nuisance classifier for A-CVAE, the cross entropy loss is used for estimating the conditional entropy H(s|z) for some embodiments. Since the mutual information can be decomposed as I(z; s)=H(s)−H(s|z), this gives us an estimate for the mutual information as the marginal entropy H(s) is constant with respect to the model parameters. The MINE method directly estimates the mutual information rather than cross entropy by using a DNN model. However, the primary goal of the censoring methods is to disentangle S from Z, and thus there is no need to explicitly estimate the mutual information but its gradient for training. The MIGE method uses score function estimators to compute the gradient of mutual information, where several kernel-based score estimators are known, e.g.: Spectral Stein Gradient Estimator (SSGE); NuMethod; Tikhonov; Stein Gradient Estimator (SGE); Kernel Exponential Family Estimator (KEF); Nystrom KEF; Sliced Score Matching (SSM). The kernel-based score estimators have its hyperparameters such as a kernel length which may be adaptively chosen depending on the datasets.

For the divergence-based censoring methods, there are several approaches including but not limited to:
Minimum mean discrepancy (MMD) with biased or unbiased kernel estimates;
Pairwise MMD with random subset selection;
Discriminator of boundary equilibrium generative adversarial network (BEGAN);
HSIC (Hilbert-Schmidt independence criterion);
Optimal transport for Wasserstein distance measure.

The first two methods rely on a kernel-based estimate of the MMD score, which provides a numerical estimate of a distance between two distributions. The MMD between two distributions is known to be 0 exactly when the distributions are equivalent. By the definition of conditional probability, the independence z⊥s that we enforce also implies that the distributions q(z) and q(z|s) are equivalent, or alternatively that the distributions q(z|sᵢ) and q(z|sⱼ) are equivalent across any nuisance pairs. Thus, we can minimize the MMD between one of these pairs of distributions to force the latent representations Z to be independent of the nuisance variable. The first MMD censoring method explores the choice such that q(z)=q(z|s).

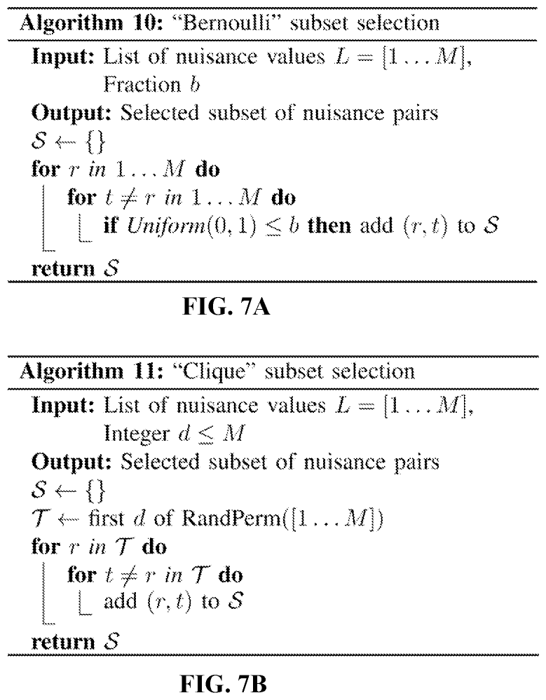

The second pairwise MMD censoring explores the choice such that q(z|sᵢ)=q(z|sⱼ) for any nuisance pairs. To compute an overall score using this “pairwise” approach, we need all combinations of two distinct values of the nuisance variables, and compute an average over these individual terms. To reduce this overhead for computational efficiency, we can consider several approximations of this pairwise MMD censoring method by selecting a subset of averaging pairs. FIGS. 7A and 7B show pseudocodes for two exemplar subset approximation algorithms. The first algorithm in FIG. 7A uses a parameter b ∈ [0,1] controlling a Bernoulli distribution to select a random subset of all possible pairs of sᵢ, sⱼ for i≠j, which we call a “Bernoulli” subset selection. The second algorithm in FIG. 7B uses an integer d ∈ {1, . . . , M} controlling the number of nuisance values included, and considers all combinations within this subset, which we call a “clique” subset selection.

In the third divergence-based censoring method, we use a neural discriminator based on the BEGAN model for some embodiments. In the BEGAN, the discriminator is parametrized as an autoencoder network, which provides a quantitative measure of divergence between real and generated data distributions by comparing its own average autoencoder loss on real data and fake data. This corresponds to an estimate of the Wasserstein-1 distance between the real and fake autoencoder losses, and that this provides a stable training signal to allow the generator to match its generated data distribution to the real data distribution. For measuring censoring scores, we can use this approach to provide a surrogate measure of the divergence between q(s) and q(z|s). Likewise MMD, minimizing this distance allows us to reduce the dependence of S and Z.

### Automated Transfer Learning: AutoTransfer

The present disclosure is based on a recognition that there are many algorithms and methods for the transfer learning framework to make the AI model robust against domain shifts and nuisance variations. For example, there are different censoring modes and censoring methods to disentangle nuisance factors from the latent variables as described above for a variety of pre-shot regularization methods. Also the present disclosure is based on a recognition that there is no single transfer learning approach, that can achieve the best performance across any arbitrary datasets, because of the no free-lunch theorem. Accordingly, the core of this invention is to automatically explore different transfer learning approaches suited for target datasets on top of the architecture exploration based on the AutoBayes framework. The method and system of the present invention are called AutoTransfer which performs an automated searching for best transfer learning approach over multiple set of algorithms.

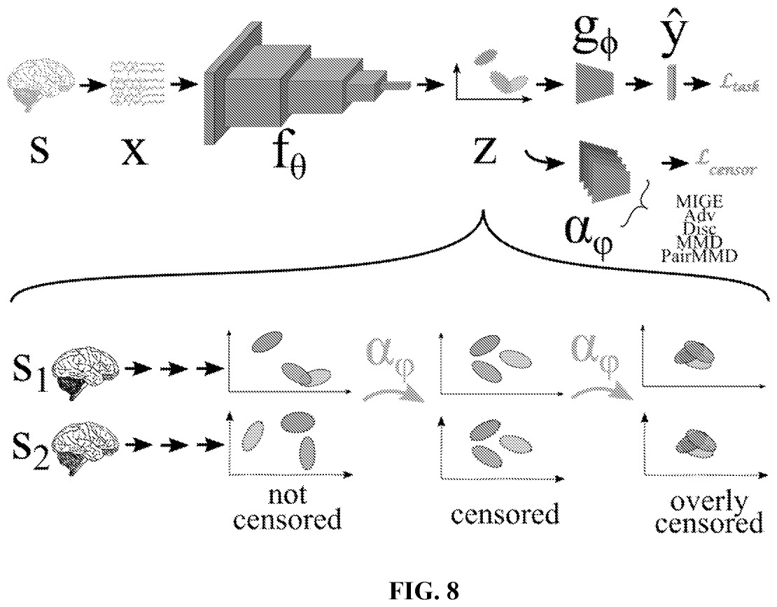

FIG. 8 shows an exemplar schematic of the AutoTransfer framework. The AI model has the main pipeline to predict Y from X via the encoder model f and the classifier model g. The encoder and classifier models are specified by some trainable parameters. The latent variables Z are generated by the encoder model at an intermediate layer of the main pipeline. There are a set of auxiliary regularization modules or blocks to disentangle nuisance variations S from the latent variables Z. For example, the data X is a measurement from electroencephalography (EEG) sensors of a subject ID S to predict motion imagery class Y for brain-computer interface systems. The key component in the AutoTransfer of the present disclosure is the use of the set of different regularization modules to explore because some censoring algorithms may work well in some situations while they may hurt the task prediction performance in different situations. The set of auxiliary regularization modules is based on different censoring modes such as marginal censoring mode, conditional censoring mode, and complementary censoring modes, and different censoring methods including but not limited to: adversarial censoring method; MINE censoring method; MIGE censoring method; BEGAN discriminator censoring method; MMD censoring method; pairwise MMD censoring method; HSIC censoring method; optimal transport censoring method. In some embodiments, multiple censoring algorithms are simultaneously used likewise A-CVAE model.

The latent variables Z should be discriminative enough to predict Y, while Z should be invariant across different nuisance variations S. For example, if the distribution of Z is well clustered depending on the task label Y, it leads to higher task classification performance in general. However, if the cluster distribution is sensitive to different subjects when changing a brain-computer interface from a subject S₁ to another subject S₂, it may have a less generalizability for totally new unseen subjects. The set of different censoring modules may enforce subject-invariant latent representation Z, while some of them may overly censor the nuisance factors, which can in turn degrade the task performance. The present invention allows the AutoTransfer framework to automatically find the best censoring module from the set of regularization modules. For example, the best regularization module can be identified by using an external optimization method, including but not limited to: reinforcement learning, evolutionary strategy, differential evolution, particle swarm, genetic algorithm, annealing, Bayesian optimization, hyperband, and multi-objective Lamarckian evolution, to explore different combinations of discrete and continuous hyperparameter values that specify the regularization modules. Specifically, a set of the best module pairs can be automatically derived by measuring the expected task performance in validation datasets. In some embodiments, the best regularization modules are further combined by an ensemble stacking, such as linear regression, multi-layer perceptron, or attention network, in cross-validation settings.

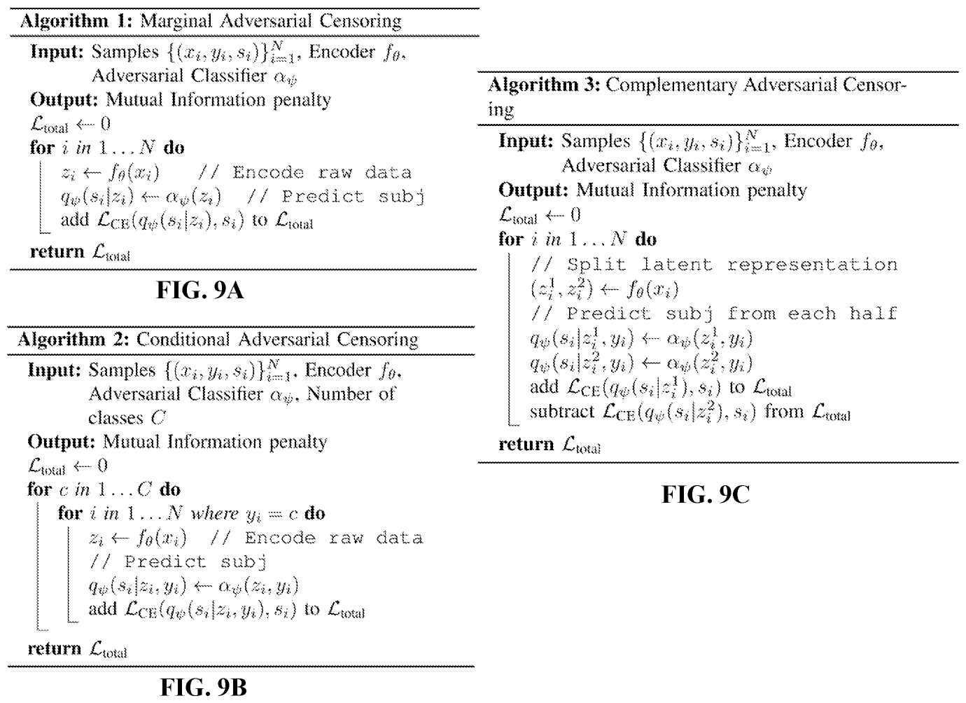

FIGS. 9A, 9B, and 9C show exemplar pseudocodes describing adversarial censoring methods used as one of regularization modules in the marginal censoring mode, conditional censoring mode, and complementary censoring mode, respectively. Those adversarial censoring modules consider minimizing the conditional mutual information between Z and S given Y using an adversarial nuisance classifier model that maps latent representations Z to a probability distribution over the nuisance variable S. Specifically, we train the adversary module's parameters to minimize a standard cross entropy loss for its prediction task. This can be seen as minimizing an upper bound on the conditional entropy H(s|z).

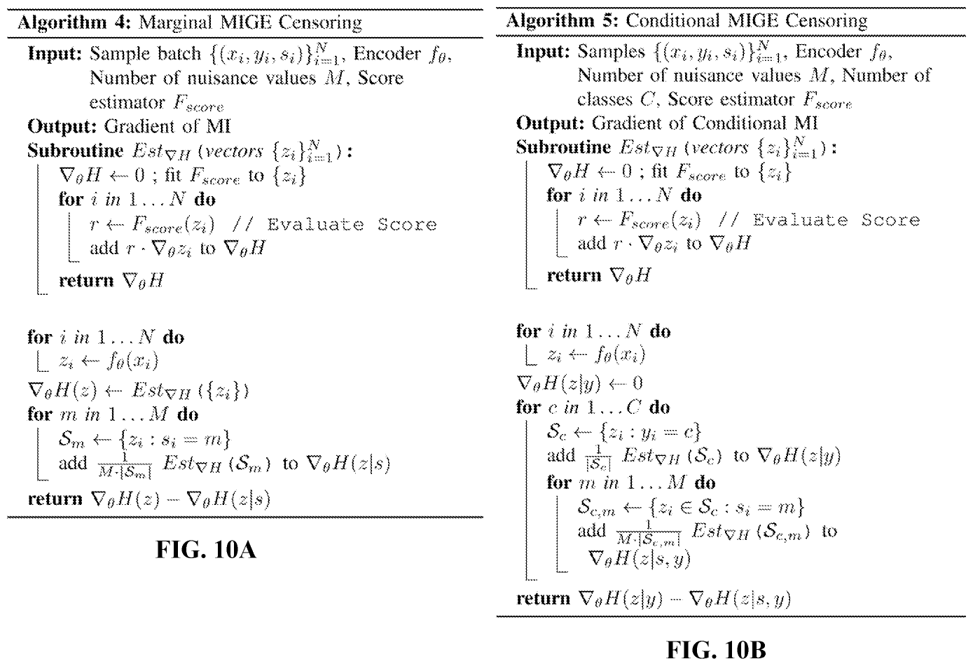

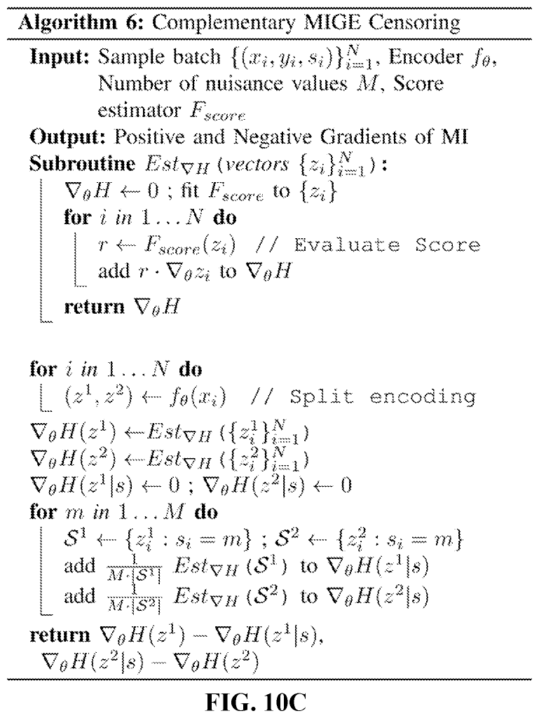

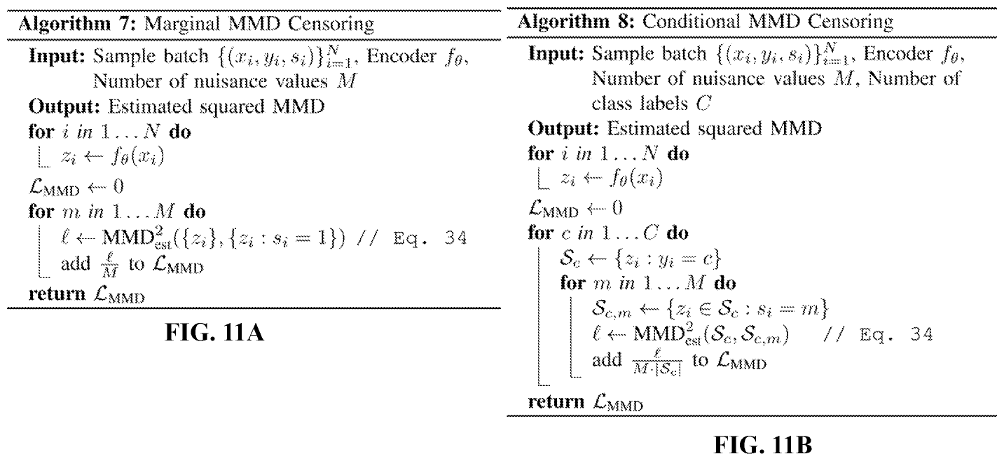

FIGS. 10A, 10B, and 10C show exemplar pseudocodes describing MIGE censoring methods used as one of regularization modules in the marginal censoring mode, conditional censoring mode, and complementary censoring mode, respectively. Considering the difficulty of estimating mutual information in high dimensions, MIGE provides an efficient method to estimate the gradient of mutual information directly. This suffices for regularization purposes, in which an objective function containing a mutual information term will be minimized by gradient descent. Specifically, the MIGE calculates the gradient of mutual information by sampling from an implicit pushforward distribution q(x, y, s) for a sampling tuple (x, y, s) from the data distribution and its latent representations Z. The MIGE censoring method uses several score function estimators, including but not limited to: SSGE; kscore; NuMethod; Tikhonov; and Stein. One benefit of MIGE censoring includes the fact that MIGE censoring does not need alternating optimizations used for adversarial training which is often unstable or sensitive to an adversarial coefficient.

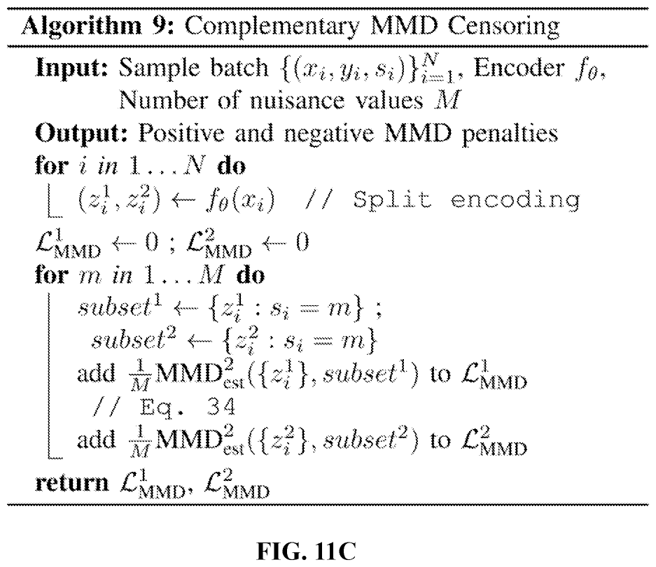

FIGS. 11A, 11B, and 11C show exemplar pseudocodes describing MMD censoring methods used as one of regularization modules in the marginal censoring mode, conditional censoring mode, and complementary censoring mode, respectively. The MMD censoring method serves as a desirable measure of divergence between two distributions because it makes no assumptions about the parametric form of the distribution being measured, and because it can be approximated efficiently and simply using a kernel estimator from a batch of samples. The MMD is an integral probability metric, describing the divergence between two distributions as the difference between the expected value of a test function under each distribution, for some worst cases from a class of functions. The MMD censoring method provides an unbiased empirical estimate of the squared MMD score with a unit ball in a universal reproducing kernel Hilbert space using a suitable kernel function. Note that this estimate includes hyperparameters defining the kernel; such as a length scale of a radial basis function (RBF) kernel matrix. The length scale can be adjusted by some methods like the median heuristic. Specifically, each time we construct a kernel matrix for a batch of samples, we set the length scale to the median pairwise L2 distance between points in the batch. To compute this conditional censoring penalty for a batch of encoded examples, we compute a term for each class-conditional subset of the batch, and average over these terms. We weight each term in the average using inverse class frequencies, which corresponds to enforcing a uniform class prior, and accounts for the possibility of class imbalance in our batching procedure.

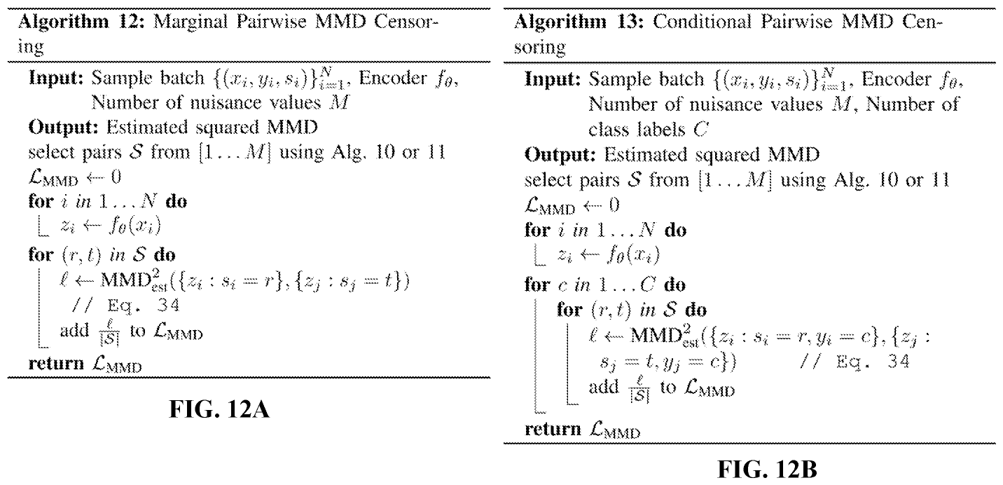

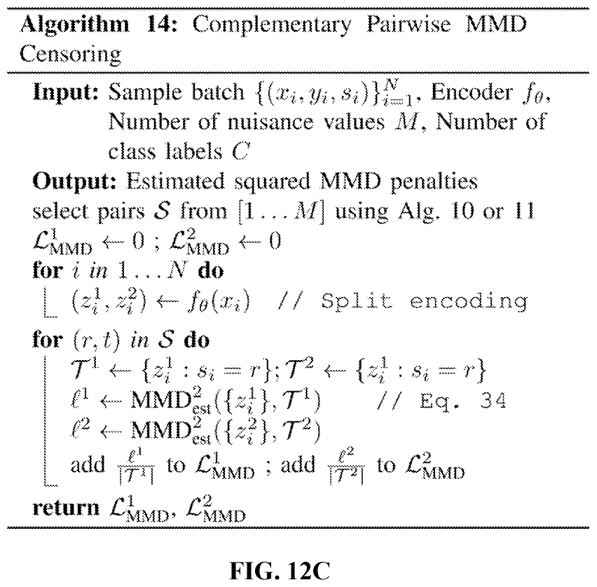

FIGS. 12A, 12B, and 12C show exemplar pseudocodes describing pairwise MMD censoring methods used as one of regularization modules in the marginal censoring mode, conditional censoring mode, and complementary censoring mode, respectively. By close analogy to the MMD censoring method, the pairwise MMD censoring method computes a penalty for minimizing the average divergence across each nuisance-conditional distribution with a quantitative surrogate. This pairwise MMD censoring approach enforces the conditional independence by computing a similar term for each class-conditional subset of a batch. As before, we may take a weighted average across classes to account for possible class imbalance in our sample batches in some embodiments. The subset selection is realized, e.g., by the Bernoulli and clique approximations in FIGS. 7A and 7B.

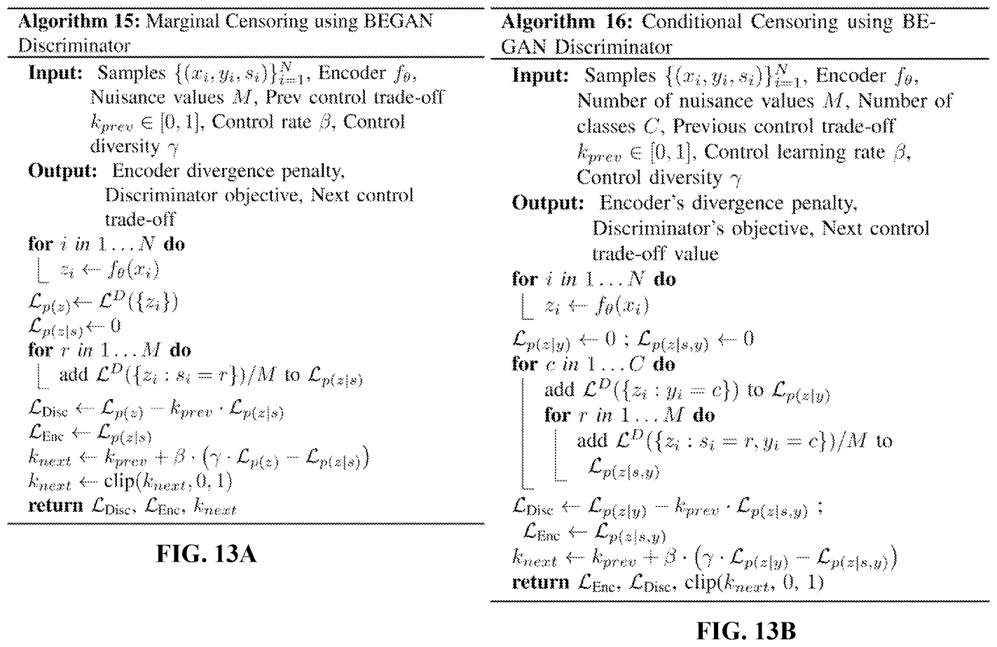

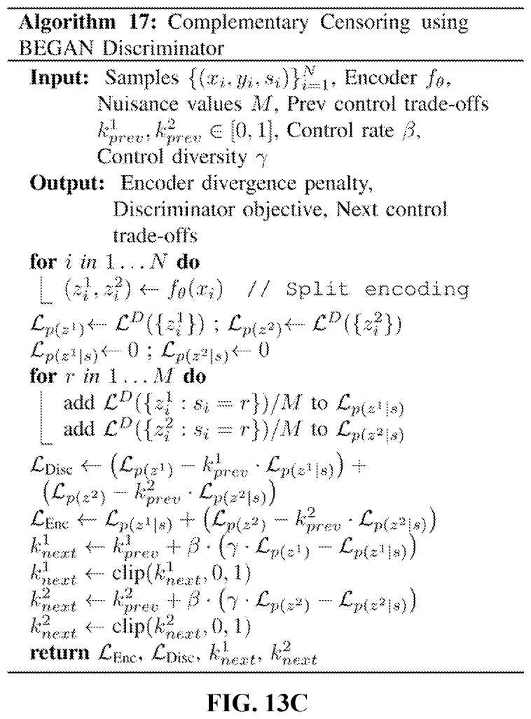

FIGS. 13A, 13B, and 13C show exemplar pseudocodes describing pairwise MMD censoring methods used as one of regularization modules in the marginal censoring mode, conditional censoring mode, and complementary censoring mode, respectively. BEGAN uses an adversarial training scheme to learn a generative model. A generator network tries to approximately map samples from a Gaussian distribution in its latent space to samples from the target data distribution, while a discriminator network tries to distinguish real and fake data samples. The key component of this model is to use an autoencoder as the discriminator, with a training objective designed so that the discriminator computes a lower bound on the Wasserstein-1 distance between the distribution of its autoencoder loss on real and generated data. In other words, the discriminator distinguishes the two data distributions by trying to learn an autoencoder map that works well only for the “true” data distribution, while the generator tries to produce data that matches the “true” data distribution and therefore is well-preserved by this autoencoder map. They further stabilize the training of their discriminator model by introducing a trade-off parameter to adaptively scale the magnitude of the discriminator's loss terms for real and generated data. This allows successful training without the need for common GAN training tricks such as custom scheduling or pre-training of one of the models. The role of the discriminator is to provide a surrogate objective so that the generator can bring two distributions from different domains closer together. This can be easily adapted to provide a signal that allows the encoder model to minimize the divergence. We use the alternating optimization algorithm from BEGAN, but substitute the distribution of “real” data with q(z), and substitute the distribution of “generated” data with q(z|s). We compute a loss term in this way for each possible value of the nuisance variables, and average across these values. Note that in the alternating optimization the discriminator and encoder are optimized in separate steps, using the two loss terms. The BEGAN optimization algorithm includes an additional input which controls the relative magnitude of these loss terms to maintain balance between these two models.

### Automated Pre-/Post-Processing

The above description of the AutoTransfer framework in the present invention is specifically suited for pre-shot transfer learning, also known as domain generalization, when there is no available test datasets in a new target domain. Nevertheless, the AutoTransfer can also improve the post-shot transfer learning, also known as online domain adaptation, because of the high resilience to domain shifts. The post-shot learning includes zero-shot learning where un-labeled data in a target domain is available, and few-shot learning where some labeled data in a target domain is available to fine-tune the pre-trained AI model. For some embodiments, the post-shot fine-tuning is carried out on the fly of testing phase in an online fashion when a new data is available with or without a task label. In post-shot adaptation phase, the pre-trained AI model optimized by the AutoTransfer is further updated by a set of calibration datasets in a target domain or a new user. The update is accomplished by domain adaptation techniques including but not limited to: pseudo-labeling, soft labeling, confusion minimization, entropy minimization, feature normalization, weighted z-scoring, continual learning with elastic weight consolidation, FixMatch, MixUp, label propagation, adaptive layer freezing, hyper network adaptation, latent space clustering, quantization, sparsification, zero-shot semi-supervised updating, and few-shot supervised fine-tuning.

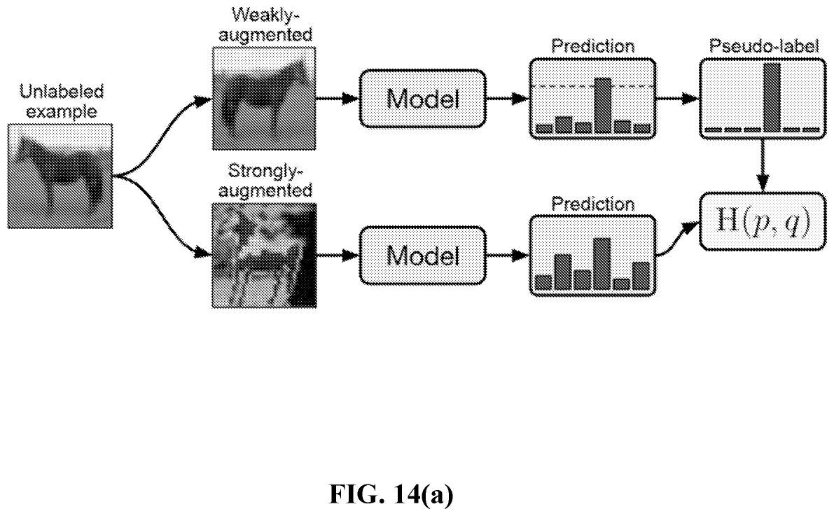

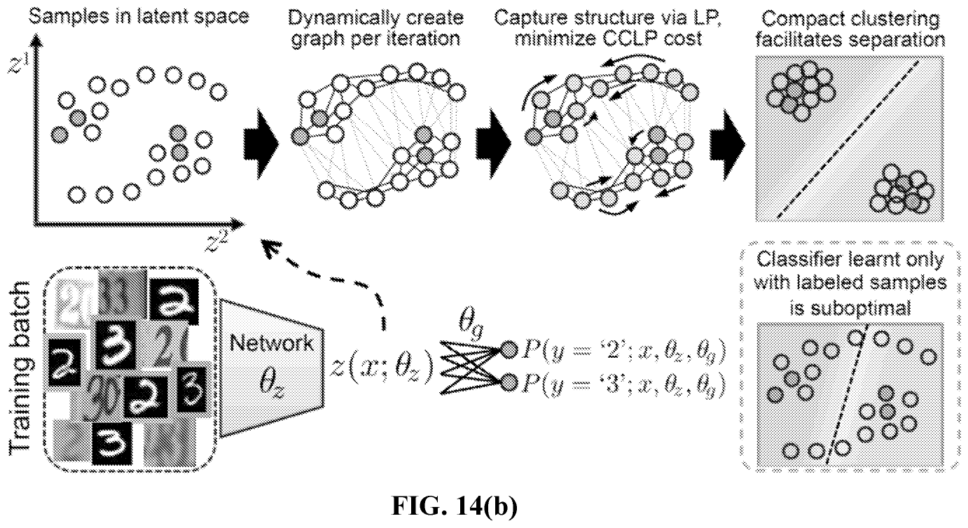

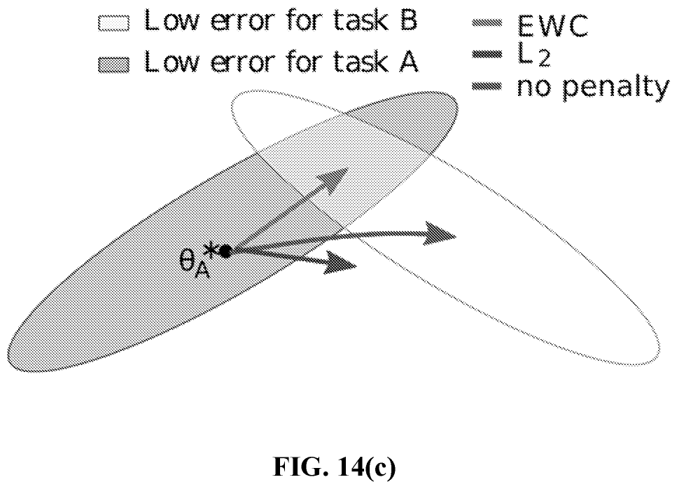

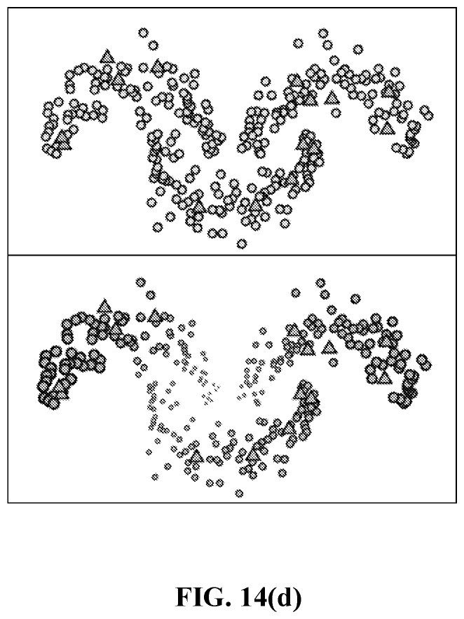

In an analogous way of exploring different censoring methods, the AutoTransfer can search for the best post-shot adaptation method among available different approaches, according to some embodiments of the present invention. FIGS. 14(a), 14(b), 14(c) and 14(d) show an exemplar set of post-processing modules to select in the post-shot phase. The selection is realized by various optimization methods including a Bayesian optimization for a new validation dataset in either source or target domains.

FIG. 14(a) shows an exemplar schematic of FixMatch method. A keakly-augmented data is fed into the AI model to obtain predictions. When the predicted score is above a threshold, the prediction is converted to a one-hot pseudo-label. Then, we compute the model's prediction for a strong augmentation of the same data. The model is trained to make its prediction on the strongly-augmented version match the pseudo-label via a cross-entropy loss minimization.

FIG. 14(b) illustrates another exemplar post-processing method based on semi-supervised learning with compact latent space clustering. It dynamically constructs a graph in the latent space at each training iteration, propagates labels to capture the manifold's structure, and regularizes it to form a single, compact cluster per class to facilitate separation.

FIG. 14(c) illustrates another example of post-processing methods based on continual learning with elastic weight consolidation. It ensures a task A is remembered while training on a task B. Training trajectories are illustrated in a parameter space, with parameter regions leading to good performance on task A and on task B. When taking gradient steps according to task B alone, we will minimize the loss of task B, but may destroy what we have learned for task A. On the other hand, when we constrain each weight with the same coefficient, the restriction imposed is too severe and we can remember task A only at the expense of not learning task B. Hence, the elastic weight consolidation conversely finds a solution for task B without incurring a significant loss on task A by explicitly computing how important weights are for task A.

In Diagram of FixMatch, a weakly-augmented image (top) is fed into the model to obtain predictions (red box). When the model assigns a probability to any class which is above a threshold (dotted line), the prediction is converted to a one-hot pseudo-label. Then, the model's prediction for a strong argumentation of the same image (bottom) is computed. The model is trained to make its prediction on the strongly-augmented version match the pseudo-label via a cross-entropy loss.

FIG. 14(d) illustrates yet another example of post-processing methods based on label propagation for semi-supervised learning. Triangles denote labeled, and circles un-labeled training data, respectively. Ground truth labels are propagated to generate pseudo-labels inferred by diffusion that are used to train the AI model according to the confidence of the pseudo-label prediction on the manifold.

According to some embodiments of the present invention, the method dynamically constructs a graph in the latent space of a network at each training iteration, propagates labels to capture the manifold's structure, and regularizes it to form a single, compact cluster per class to facilitate separation.

EWC (elastic weight consolidation) ensures task A is remembered while training on task B. Training trajectories are illustrated in a schematic parameter space, with parameter regions leading to good performance on task A (gray) and task B (cream color). After learning the first task, the parameters are at θ*A. If we take gradient steps according to task B along (blue arrow), the method minimizes the loss of task B. If we constrain each weight with the same coefficient (green arrow), the restriction imposed is too severe and we can remember task A only at the expense of not learning task B. EWC, conversely, finds a solution for task B without incurring a significant loss on task A (red arrow) by explicitly computing how important weights are for task A.

In the label propagation on manifolds toy example, triangles denoted labeled, and circulates un-labeled training data, respectively. The top figure illustrates color-coded ground truth for labeled points, and gray color for unlabeled points. The bottom figure illustrates color-coded pseudo-labels inferred by diffusion that are used to train the CNN. In this case, the size reflects the certainty of the pseudo-label prediction.

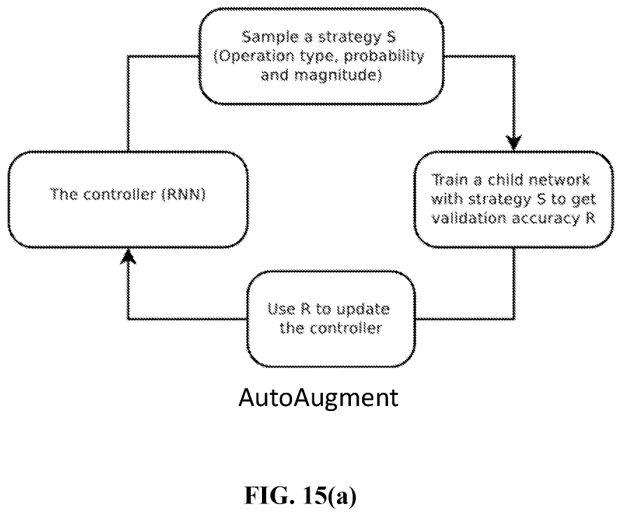

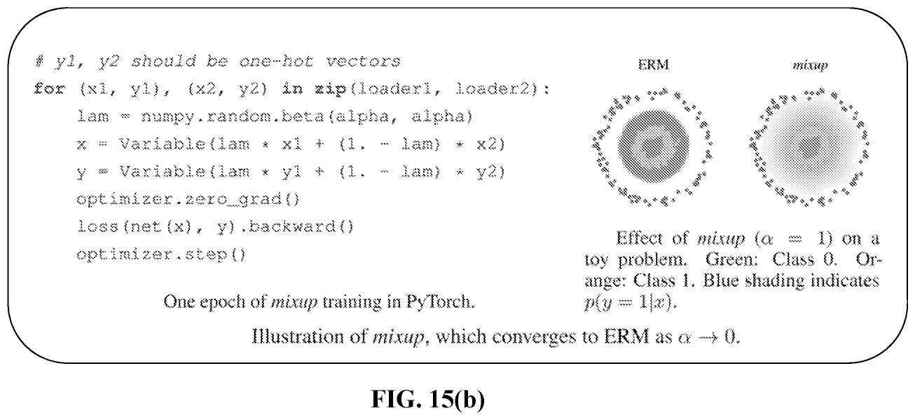

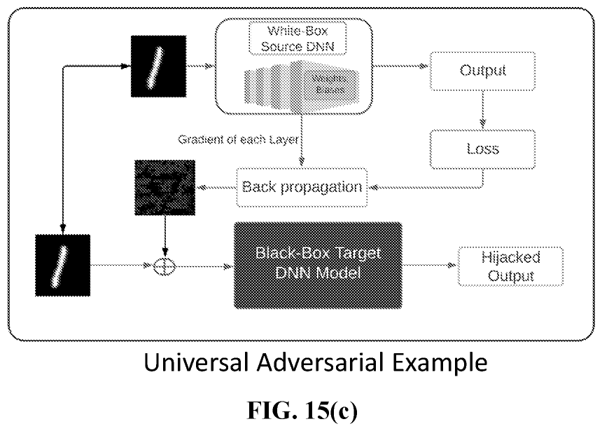

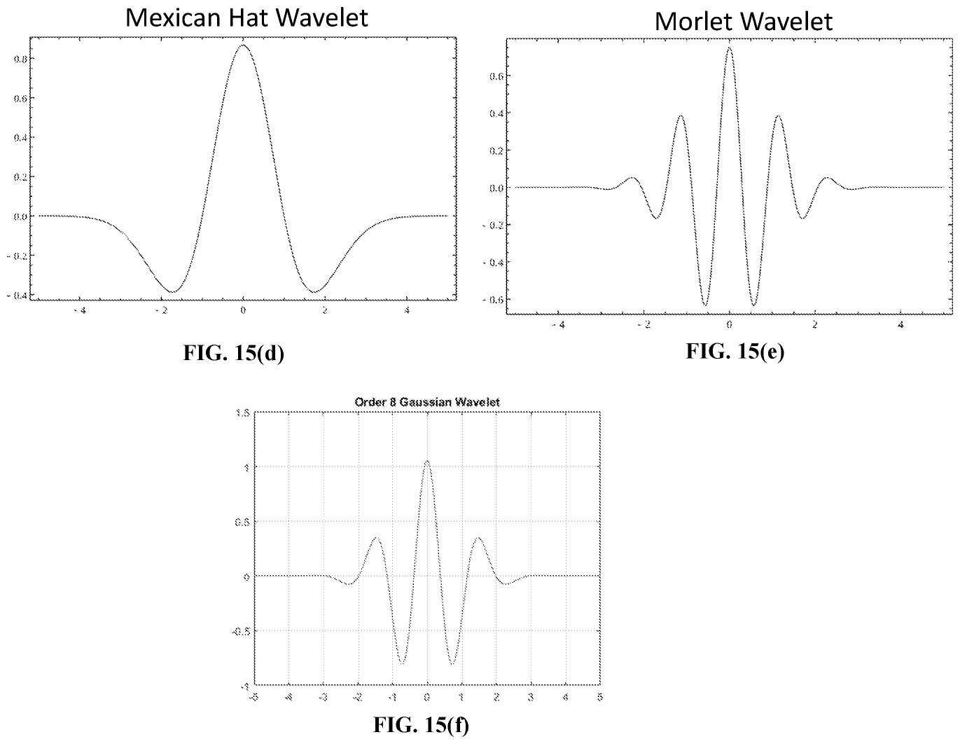

In addition to post-processing, the AutoTransfer can explore different pre-processing approaches in prior to feeding a raw data into the AI model. The pre-processing methods include but not limited to: data normalization, data augmentation, AutoAugment, an universal adversarial example (UAE), spatial filtering such as common spatial pattern filtering, principal component analysis, independent component analysis, short-time Fourier transform, filter bank, vector auto-regressive filter, self-attention mapping, robust z-scoring, spatio-temporal filtering, and wavelet transforms. For example, a stochastic UAE which adversarially disturbs a task classification is used as a data augmentation to tackle more challenging artifacts in datasets. There are many associated hyperparameters to specify the pre-processing. For example, continuous wavelet transform may have a choice of filter-bank resolutions and mother wavelet kernels such as Mexican hat wavelet shown in FIG. 15(a), Morlet wavelet shown in FIG. 15(b), and Gaus8 wavelet shown in FIG. 15(c). As there are many pre-processing approaches with many associated hyperparameters, there is a need for an automated exploration to find the best approach without requiring intensive human's labor. FIG. 15 shows an exemplar set of pre-processing modules used for an automatic selection. In some embodiments, the AutoTransfer also automatically explore a variety of such pre-processing methods so that the AI model can realize a high accuracy in the task prediction while achieving a robustness against domain shifts. The selection is realized by a Bayesian optimization in some embodiments.

FIG. 15(d) shows an example of pre-processing methods based on AutoAugment. It uses a search method (e.g., reinforcement learning) to find better data augmentation policies. An auxiliary controller model (e.g., recurrent neural network: RNN) predicts an augmentation policy from a search space. A child network with a fixed architecture is trained to convergence achieving accuracy. The accuracy score will be used as a reward value with the policy gradient method to update the controller model so that it can generate better policies over time. The augmentation policy includes but not limited to: noise injection; spatio-temporal shifting/masking; interpolation/extrapolation; quantization.

FIG. 15(e) illustrates another example of pre-processing modules based on MixUp. It augments training data by superposing two distinct data by randomly sampled mixture coefficient. The key idea of MixUp is to mix task labels Y in addition to data X. For some embodiments, MixUp uses multiple data instances more than 2 are jointly combined with more mixture parameters. Yet another embodiment uses an auxiliary DNN model to mix multiple samples from training data to produce non-linear mapping to augment.

FIG. 15(f) shows another example of augmentation based on UAE framework. An auxiliary DNN model is trained as an off-line generator to generate a universal adversary given training dataset. At the online stage, the DNN model can generate the adversary w/o any back-propagation or model-specific gradient while it tries to disturb the task accuracy as much as possible as the worst-case artifacts under a constrained perturbation limit. The trained DNN model is then used to augment the training data when the main AI model is trained based on augmented data. Because of the adversarial attack by the UAE framework, the main AI model can be more generalized against adversarial domain shifts.

The figure shows the overview of our framework of using a search method (e.g., Reinforcement Learning) to search for better data augmentation policies. A controller RNN predicts an augmentation policy which is trained to convergence achieving accuracy R. The reward R will be used with the policy gradient method to update the controller so that it can generate better policies over time

### Model Implementation

Each of the DNN block is configured with hyperparameters to specify a set of layers with neuron nodes, mutually connected with trainable variables to pass a signal from the layers to layers sequentially. The trainable variables are numerically optimized with the gradient methods, such as stochastic gradient descent, adaptive momentum, Ada gradient, Ada bound, Nesterov accelerated gradient, and root-mean-square propagation. The gradient methods update the trainable parameters of the DNN blocks by using the training data such that output of the DNN blocks provide smaller loss values such as mean-square error, cross entropy, structural similarity, negative log-likelihood, absolute error, cross covariance, clustering loss, divergence, hinge loss, Huber loss, negative sampling, Wasserstein distance, and triplet loss. Multiple loss functions are further weighted with some regularization coefficients according to a training schedule policy.

In some embodiments, the DNN blocks is reconfigurable according to the hyperparameters such that the DNN blocks are configured with a set of fully-connect layer, convolutional layer, graph convolutional layer, recurrent layer, loopy connection, skip connection, and inception layer with a set of nonlinear activations including rectified linear variants, hyperbolic tangent, sigmoid, gated linear, softmax, and threshold. The DNN blocks are further regularized with a set of dropout, swap out, zone out, block out, drop connect, noise injection, shaking, and batch normalization. In yet another embodiment, the layer parameters are further quantized to reduce the size of memory as specified by the adjustable hyperparameters. For another embodiment of the link concatenation, the system uses multi-dimensional tensor projection with dimension-wise trainable linear filters to convert lower-dimensional signals to larger-dimensional signals for dimension-mismatched links.

Another embodiment integrates AutoML into AutoBayes and AutoTransfer for hyperparameter exploration of each DNN blocks and learning scheduling. Note that AutoTransfer and AutoBayes can be readily integrated with AutoML to optimize any hyperparameters of individual DNN blocks. More specifically, the system modifies hyperparameters by using reinforcement learning, evolutionary strategy, differential evolution, particle swarm, genetic algorithm, annealing, Bayesian optimization, hyperband, and multi-objective Lamarckian evolution, to explore different combinations of discrete and continuous hyperparameter values.

The system of invention also provides further testing step to adapt as a post training step which refines the trained DNN blocks by unfreezing some trainable variables such that the DNN blocks can be robust to a new dataset with new nuisance variations such as new subject. This embodiment can reduce the requirement of calibration time for new users of HMI systems. Yet another embodiment uses exploration of different pre-processing methods.

### Exemplar System

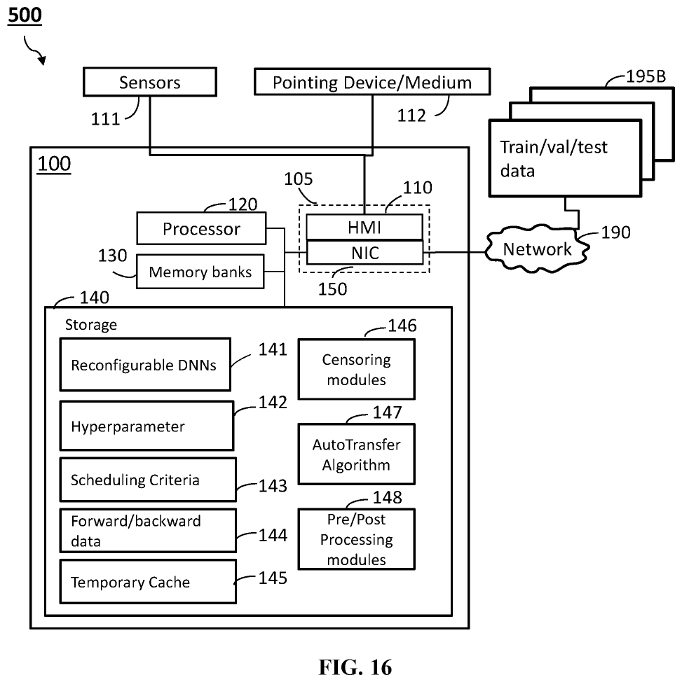

FIG. 16 is a block diagram illustrating an example of a system 500 for the automated construction of an artificial neural network architecture, according to some embodiments of the present disclosure. The system 500 includes a set of interfaces and data links 105 configured to receive and send signals, at least one processor 120, a memory (or a set of memory banks) 130 and a storage 140. The processor 120 performs, in connection with the memory 130, computer-executable programs and algorithms stored in the storage 140. The set of interfaces and data links 105 may include a human machine interface (HMI) 110 and a network interface controller 150. The computer-executable programs and algorithms stored in the storage 140 may be reconfigurable deep neural networks (DNNs) 141, a hyperparameter(s) 142, scheduling criteria 143, forward/backward data 144, temporary caches 145, censoring modules 146, AutoTransfer algorithm 147, and pre-/post-processing modules 148.

The system 500 can receive the signals via the set of interfaces and data links. The signals can be datasets of training data, validation data and testing data and the signals that include a set of random number factors in multi-dimensional signals X, wherein part of the random number factors are associated with task labels Y to identify, and nuisance variations S from different domains.

In some cases, each of the reconfigurable DNN blocks (DNNs) 141 is configured either for encoding the multi-dimensional signals X into latent variables Z, decoding the latent variables Z to reconstruct the multi-dimensional signals X, classifying the task labels Y, estimating the nuisance variations S, regularization estimating the nuisance variations S, or selecting a graphical model. In this case, the memory banks further include hyperparameters, trainable variables, intermediate neuron signals, and temporary computation values including forward-pass signals and backward-pass gradients.

The at least one processor 120 is configured to, in connection with the interface and the memory banks 105, submit the signals and the datasets into the reconfigurable DNN blocks 141. Further the at least one processor 120 executes a Bayesian graph exploration using the Bayes-Ball algorithm 146 to reconfigure the DNN blocks such that redundant links are pruned to be compact by modifying the hyperparameters 142 in the memory banks 130. The AutoTransfer explores different auxiliary regularization modules and pre-/post-processing modules to improve the robustness against nuisance variations.

The system 500 can be applied to design of human-machine interfaces (HMI) through the analysis of user's physiological data. The system 500 may receive physiological data 195B as the user's physiological data via a network 190 and the set of interfaces and data links 105. In some embodiments, the system 500 may receive electroencephalogram (EEG) and electromyogram (EMG) from a set of sensors 111 as the user's physiological data.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the embodiments of the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A system for automated construction of an artificial neural network architecture, comprising:
a set of interfaces and data links configured to receive and send signals, wherein the signals include datasets of training data, validation data and testing data, wherein the signals include a set of random variable factors in multi-dimensional signals X, wherein part of the random variable factors are associated with task labels Y to identify, and nuisance variations S;
a set of memory banks to store a set of reconfigurable deep neural network (DNN) blocks, wherein each of the reconfigurable DNN blocks is configured with main task pipeline modules to identify the task labels Y from the multi-dimensional signals X and with a set of auxiliary regularization modules to adjust disentanglement between a plurality of latent variables Z and the nuisance variations S, wherein the memory banks further include hyperparameters, trainable variables, intermediate neuron signals, and temporary computation values including forward-pass signals and backward-pass gradients;
at least one processor, in connection with the interface and the memory banks, configured to submit the signals and the datasets into the reconfigurable DNN blocks, wherein the at least one processor is configured to execute an exploration over a set of graphical models, a set of pre-shot regularization methods, a set of pre-processing methods, a set of post-processing methods, and a set of post-shot adaptation methods, to reconfigure the reconfigurable DNN blocks such that task prediction is insensitive to the nuisance variations S by modifying the hyperparameters in the memory banks.

2. The system of claim 1, wherein the at least one processor further executes steps of:
modifying the hyperparameters to specify the set of graphical models representing a Bayesian graph model and an inference factor graph based on a Bayes-ball algorithm;
modifying the reconfigurable DNN blocks by linking graph nodes with graph edges to associate with the random variable factors with respect to the multi-dimensional signals X, the task labels Y, the nuisance variations S and the latent variables Z according to the Bayesian graph model and the inference factor graph;
training the reconfigurable DNN blocks with a variational sampling and a gradient method for the training data;
selecting the hyperparameters based on an output of the reconfigurable DNN blocks for the validation data; and
testing the trained reconfigurable DNN blocks for the testing data and new incoming data on fly to be transferred with nuisance robustness.

3. The system of claim 1, wherein the at least one processor further executes steps:
modifying the hyperparameters to specify the set of pre-shot regularization methods based on different censoring modes and censoring methods, wherein the censoring modes are based on a marginal censoring mode, a conditional censoring mode, a complementary censoring mode, or a combination thereof, wherein the censoring methods are based on divergence censoring methods, mutual information censoring methods, and a variant thereof;
associating the set of auxiliary regularization modules with the reconfigurable DNN blocks such that at least one of latent nodes Z is disentangled from at least one of nuisance variations S according to the set of pre-shot regularization methods;
training the reconfigurable DNN blocks with the set of auxiliary regularization modules based on the training data; and
selecting the hyperparameters for the set of censoring modes and the set of censoring methods based on the output of the reconfigurable DNN blocks for the validation data.

4. The system of claim 3, wherein the censoring methods include an adversarial censoring method, a mutual information neural estimation (MINE) censoring method, a mutual information gradient estimation (MIGE) censoring method, a maximum mean discrepancy (MMD) censoring method, a pairwise maximum mean discrepancy (MMD) censoring method, a boundary equilibrium generative adversarial network (BEGAN) discriminator censoring method, a Hilbert-Schmidt independence criterion (HSIC) censoring method, an optimal transport censoring method, and a variant thereof.

5. The system of claim 1, wherein the at least one processor executes steps:
modifying the hyperparameters to specify the set of pre-processing methods based on a spatial filtering, spatio-temporal filtering, wavelet transforms, vector auto-regressive filter, self-attention mapping, robust z-scoring, normalization, data augmentation, universal adversarial example, and a variant thereof; and
modifying the training data, validation data, and testing data to feed in the reconfigurable DNN blocks according to the set of pre-processing methods.

6. The system of claim 1, wherein the set of post-processing methods include a cross validation voting, ensemble stacking, score averaging, and a variant thereof.

7. The system of claim 1, wherein the set of post-shot adaptation methods include pseudo-labeling, soft labeling, confusion minimization, entropy minimization, feature normalization, weighted z-scoring, elastic weight consolidation, label propagation, adaptive layer freezing, hyper network adaptation, latent space clustering, quantization, sparsification, and a variant thereof, wherein the reconfigurable DNN blocks are refined by unfreezing a combination of the trainable variables such that the reconfigurable DNN blocks adapt to a new-domain dataset.

8. The system of claim 2, wherein the variational sampling is employed for the latent variables with an independent distribution specified by an exponential family or non-exponential family, as its prior distribution for reparameterization tricks, and for categorical variables of unknown nuisance variations and task labels using Gumbel softmax trick to produce near-one-hot vectors based on a random number generator and a softmax temperature.

9. The system of claim 2, wherein the link concatenation further comprising a step of multi-dimensional tensor projection with a plural of trainable linear filters or bilinear filters to convert lower-dimensional signals for dimension-mismatched links.

10. The system of claim 1, wherein the reconfigurable DNN blocks are configured with a combination of fully-connect layer, convolutional layer, graph convolutional layer, recurrent layer, loopy connection, skip connection, and inception layer with a set of nonlinear activations including rectified linear variants, hyperbolic tangent, sigmoid, gated linear, softmax, and thresholding, regularized with a combination of dropout, swap out, zone out, block out, drop connect, noise injection, shaking, and batch normalization.

11. The system of claim 2, wherein the training performs updating the trainable parameters of the reconfigurable DNN blocks by using the training data such that output of the reconfigurable DNN blocks provide smaller loss values in a combination of objective functions, wherein the objective functions further include a combination of mean-square error, cross entropy, structural similarity, negative log-likelihood, absolute error, cross covariance, clustering loss, divergence, hinge loss, Huber loss, negative sampling, Wasserstein distance, and triplet loss, wherein the loss functions are weighted with a plural of regularization coefficients adjusted according to the specified training schedules.

12. The system of claim 2, wherein the gradient method employs a combination of stochastic gradient descent, adaptive momentum, Ada gradient, Ada bound, Nesterov accelerated gradient, and root-mean-square propagation for optimizing the trainable parameters of the reconfigurable DNN blocks.

13. The system of claim 1, wherein the datasets include a combination of sensor measurements further comprising:
media data such as images, pictures, movies, texts, letters, voices, music, audios, speeches, and a variant thereof;
physical data such as radio waves, optical signals, electrical pulses, temperatures, pressures, accelerations, speeds, vibrations, forces, and a variant thereof; and
physiological data such as heart rate, blood pressure, mass, moisture, electroencephalogram, electromyogram, electrocardiogram, mechanomyogram, electrooculogram, galvanic skin response, magnetoencephalogram, electrocorticography, and a variant thereof.

14. The system of claim 1, wherein the nuisance variations include a set of subject identifications, session numbers, biological states, environmental states, sensor states, locations, orientations, sampling rates, time and sensitivities.

15. The system of claim 1, wherein each of the reconfigurable DNN block further comprises hyperparameters specifying a set of layers having a set of artificial neuron nodes, wherein a pair of the neuron nodes from neighboring layers are mutually connected with a plural of trainable variables and activation functions to pass a signal from the previous layers to the next layers sequentially.

16. The system of claim 1, wherein the nuisance variations S are further decomposed into multiple factors of variations S₁, S₂, . . . , S_{N} as multiple-domain side information according to a combination of supervised, semi-supervised and unsupervised settings, wherein the latent variables are further decomposed into multiple factors of latent variables Z₁, Z₂, . . . , Z_{L} as disentangled feature vectors.

17. The system of claim 2, wherein the modifying hyperparameters employs a combination of reinforcement learning, evolutionary strategy, differential evolution, particle swarm, genetic algorithm, annealing, Bayesian optimization, hyperband, and multi-objective Lamarckian evolution, to explore different combinations of discrete and continues hyperparameter values.

18. The system of claim 1, wherein the set of hyperparameters compromises a set of training schedules including an adaptive control of learning rates, regularization weights, factorization permutations, and policy to prune less-priority links, by using a belief propagation to measure a discrepancy between the training data and the validation data.

19. A computer-implemented method for automated construction of an artificial neural network architecture comprising:
feeding datasets of training data, validation data and testing data, wherein the datasets include a set of random variable factors in multi-dimensional signals X, wherein part of the random variable factors are associated with task labels Y to identify, and nuisance variations S;
configuring a set of reconfigurable deep neural network (DNN) blocks to identify the task labels Y from the multi-dimensional signals X, wherein the set of DNN blocks comprises a set of auxiliary regularization modules to adjust disentanglement between a plurality of latent variables Z and the nuisance variations S;
training the set of reconfigurable DNN blocks via a stochastic gradient optimization such that a task prediction is accurate for the training data;
exploring the set of auxiliary regularization modules to search for the best hyperparameters such that the task prediction is insensitive to the nuisance variations S for the validation data.

20. The method of claim 19, the set of regularization modules is based on different censoring modes and censoring methods, wherein the censoring modes include:
a marginal censoring mode; a conditional censoring mode; a complementary censoring mode; or a combination thereof;
and the censoring methods are based on:
divergence censoring methods; mutual information censoring methods; and a variant thereof;
wherein the censoring methods further include:
an adversarial censoring method; a mutual information neural estimation censoring method; a mutual information gradient estimation censoring method; a maximum mean discrepancy censoring method; a pairwise maximum mean discrepancy censoring method; a boundary equilibrium generative adversarial network discriminator censoring method; a Hilbert-Schmidt independence criterion censoring method; an optimal transport censoring method; and a variant thereof.
